(19) United States
(12) Patent Application Publication
(10) Pub. No.: US 2026/0332069 A1
(43) Pub. Date: Oct. 22, 2026

(54) ELECTRIC WORK MACHINE

(71) Applicant: MAKITA CORPORATION, Anjo-shi (JP)

(72) Inventors: Masatoshi ITO, Anjo-shi (JP); Masumi NISHIMURA, Anjo-shi (JP)

(73) Assignee: MAKITA CORPORATION, Anjo-shi (JP)

(21) Appl. No.: 19/646,687

(22) Filed: Apr. 14, 2026

(30) Foreign Application Priority Data
Apr. 18, 2025 (JP) 2025-068850
Apr. 7, 2026 (JP) 2026-063179

(51) Int. Cl. H02P 6/15; A01D 34/37; A01D 34/78; A01G 3/053; A01G 3/08; A01G 20/47

(52) U.S. Cl. CPC H02P 6/157; A01D 34/37; A01D 34/78; A01G 3/053; A01G 3/088; A01G 20/47

(57) ABSTRACT

An electric work machine in one aspect of the present disclosure includes a brushless DC motor, an inverter, and a control circuit. The control circuit switches a switch pattern pair at each commutation timing. The control circuit (i) alternately switches a setting of a switch pattern between a first pattern and a second pattern corresponding to the switch pattern pair that is set, and (ii) executes PWM control of an energization current to multiple windings in accordance with the switch pattern that is set. The control circuit sets the commutation timing based on a timing when a magnitude relationship between an inductance during the first pattern and an inductance during the second pattern is reversed. The control circuit sets a duty cycle of the PWM control based on a load applied to the brushless DC motor.

### CROSS-REFERENCE TO RELATED APPLICATIONS

The present application claims the benefit of Japanese Patent Application No. 2025-068850 filed on Apr. 18, 2025 and Japanese Patent Application No. 2026-063179 filed on Apr. 7, 2026 with the Japan Patent Office, the entire disclosures of which are incorporated herein by reference.

### BACKGROUND

The present disclosure relates to an electric work machine including a brushless DC (direct-current) motor as a power source.

Japanese Patent No. 7118699 discloses an electric work machine. This electric work machine can detect a rotational position of a brushless DC motor without using a rotation sensor even during low-speed rotation. The “low speed” herein refers to a speed at which a back EMF generated by rotation of the brushless DC motor is so low that the rotational position of the brushless DC motor cannot be detected from the back EMF. The brushless DC motor includes multiple terminals and multiple windings. The electric work machine includes an inverter section and a control section. The inverter section includes multiple switching elements. The multiple switching elements are provided in multiple energization paths. Each of the multiple energization paths electrically couples the multiple terminals to a DC power source. The control section drives the brushless DC motor by switching an energization pattern for the multiple windings at each specific commutation timing of the brushless DC motor and performing PWM (pulse width modulation) control of an energization current.

The control section includes, as the energization pattern, two switch patterns in which ON/OFF states of the multiple switching elements differ from each other. The control section alternately switches its switch pattern to one of the two switch patterns in synchronization with a cycle of the PWM control. In response to switching of the switch pattern, (i) an energization path from the DC power source to the brushless DC motor changes, and (ii) an inductance of the energization path changes. The control section detects the rotational position of the brushless DC motor (rotor) and sets a commutation pattern at a timing when a magnitude relationship between two inductances, each of which corresponds to one of the two switch patterns, is reversed. Therefore, this electric work machine can detect the rotational position without using a rotation sensor even during low-speed rotation.

### SUMMARY

In the above-mentioned electric work machine, a duty cycle of the PWM control is preset such that the brushless DC motor can be driven.

Here, in order to expand applications of the electric work machine, it is conceivable to configure the electric work machine such that one of multiple types of work tools can be selectively attached to the electric work machine. Each of the multiple types of work tools is driven by the brushless DC motor, but their applications differ from each other. In such an electric work machine, a load applied from the work tool to the brushless DC motor may vary significantly depending on the attached work tool. Therefore, if the duty cycle is preset to a constant value, the brushless DC motor may fail to generate enough rotational torque to drive the working tool, and the rotation of the brushless DC motor may stop. Furthermore, if the duty cycle is preset to a constant value, the rotational torque of the brushless DC motor may increase excessively, and the work tool may be driven at an unnecessarily high speed.

In one aspect of the present disclosure, it is desirable that an electric work machine including a brushless DC motor can detect a rotational position of the brushless DC motor without using a rotation sensor during low-speed rotation of the brushless DC motor, and properly rotate the brushless DC motor even if a load applied to the brushless DC motor changes significantly.

One aspect of the present disclosure provides an electric work machine including a brushless DC motor, an inverter, and a control circuit. The inverter drives the brushless DC motor. The control circuit controls energization of the brushless DC motor by the inverter. That is, the control circuit controls the inverter, thereby controlling the brushless DC motor.

The brushless DC motor (i) is a power source for operating a work tool and (ii) includes multiple terminals and multiple windings. The inverter includes (i) multiple energization paths each coupling a corresponding one of the multiple terminals to a DC power source, and (ii) multiple switching elements each provided in one of the multiple energization paths. The inverter is configured to control energization and an energizing direction to the multiple windings via the multiple switching elements.

The control circuit is configured to perform a first operation, a second operation, a third operation, a fourth operation, and a fifth operation. The first operation includes switching a switch pattern pair at each commutation timing of the brushless DC motor. The switch pattern pair includes a first pattern and a second pattern. Each of the first pattern and the second pattern specifies ON/OFF states of the multiple switching elements for energizing the multiple windings via the inverter. The ON/OFF state of the first pattern differs from the ON/OFF state of the second pattern.

The second operation alternately switches a setting of a switch pattern between the first pattern and the second pattern corresponding to the switch pattern pair that is set, in synchronization with a PWM control cycle. The third operation includes executing PWM control of an energization current to the multiple windings in synchronization with the PWM control cycle. The third operation includes turning each of the multiple switching elements ON or OFF in accordance with the switch pattern switched by the second operation.

The fourth operation includes setting the commutation timing based on a timing when a magnitude relationship between an inductance of a first energization path and an inductance of a second energization path is reversed. The fourth operation may include detecting the rotational position of the brushless DC motor based on the timing. The first energization path is a path in the multiple windings through which a current from the DC power source flows when the switch pattern is set to the first pattern. The second energization path is a path in the multiple windings through which a current from the DC power source flows when the switch pattern is set to the second pattern.

When the switch pattern is switched as described above, the inductance of the first energization path and the inductance of the second energization path can be different from each other even if the rotational position is the same. One reason for this involves a difference in magnetic permeability due to magnets provided in the brushless DC motor (specifically, the rotor). Utilizing such properties, the control circuit changes the inductance of stator windings by alternately switching the switch pattern (third operation). The control circuit detects the rotational position of the brushless DC motor (rotor) at the timing when the magnitude relationship between the inductances is reversed (fourth operation).

Therefore, according to the electric work machine of the present disclosure, the rotational position can be detected without using a rotation sensor even during low-speed rotation.

The fifth operation includes setting a duty cycle of the PWM control based on a load applied from the work tool to the brushless DC motor. The duty cycle is (i) a proportion of time during which the inverter is controlled in accordance with the first pattern to a length of the PWM control cycle, and/or (ii) a proportion of time during which the inverter is controlled in accordance with the second pattern to the length of the PWM control cycle.

Accordingly, according to the electric work machine of the present disclosure, the rotational position can be properly detected even if the load varies significantly depending on the type of work tool.

In other words, in order to detect the rotational position based on the timing when the magnitude relationship between the inductances is reversed, it is necessary for the brushless DC motor to be rotating due to the energization by the PWM control. However, if the load changes due to, for example, replacement of the work tool, it may happen that the brushless DC motor cannot be rotated and the rotational position cannot be detected.

In contrast, in the electric work machine of the present disclosure, the duty cycle is set in accordance with the load. This allows the brushless DC motor to rotate even if the work tool is replaced.

Therefore, according to the electric work machine of the present disclosure, even if the load changes due to replacement of the work tool or the like, the brushless DC motor can be rotated, whereby the rotational position can be detected.

### BRIEF DESCRIPTION OF THE DRAWINGS

Example embodiments of the present disclosure will be described hereinafter with reference to the accompanying drawings, in which:

FIG. 1 is a perspective view of an appearance of an electric work machine of a first embodiment;

FIGS. 2A through 2D are perspective views of example work tools that can be attached to the electric work machine shown in FIG. 1;

FIG. 3 is a block diagram showing a circuit configuration of a controller of the electric work machine;

FIG. 4 is flowchart illustrating a drive control procedure of the first embodiment;

FIG. 5 is a time chart illustrating an initial position detection operation shown in FIG. 4;

FIG. 6 is a time chart illustrating a sensorless driving operation shown in FIG. 4;

FIG. 7 is a time chart illustrating a twin-pulse driving operation shown in FIG. 4;

FIG. 8 is a time chart illustrating an output duty control operation in twin-pulse drive;

FIG. 9 is a flowchart of a twin-pulse drive process of the first embodiment;

FIG. 10 is a flowchart of a timer interrupt process of the first embodiment;

FIG. 11 is a flowchart of an output process shown in FIG. 10;

FIG. 12 is an explanatory diagram illustrating the twin-pulse drive (first drive period) of a comparative example;

FIG. 13 is an explanatory diagram illustrating the twin-pulse drive (second drive period) of the comparative example;

FIG. 14 is an explanatory diagram illustrating current changes in the twin-pulse drive of the comparative example;

FIG. 15 is an explanatory diagram illustrating the twin-pulse drive (first drive period) of a second embodiment;

FIG. 16 is explanatory diagram illustrating the twin-pulse drive (second drive period) of the second embodiment:

FIG. 17 is an explanatory diagram illustrating current changes in the twin-pulse drive of the second embodiment;

FIG. 18 is a flowchart of a part of the output process of the second embodiment;

FIG. 19 is a flowchart of another part of the output process of the second embodiment (a continuation of FIG. 18);

FIG. 20 is an explanatory diagram illustrating the twin-pulse drive of a third embodiment;

FIG. 21 is a flowchart of the twin-pulse drive process of the third embodiment;

FIG. 22 is a flowchart of the timer interrupt process of the third embodiment; and

FIG. 23 is a time chart illustrating a modification of the output duty control operation in the twin-pulse drive.

### DETAILED DESCRIPTION OF EXEMPLARY EMBODIMENTS

### 1. Overview of Embodiments

An embodiment may provide an electric work machine including at least one of:
Feature 1: a brushless direct-current (DC) motor (or a brushless motor);
Feature 2: the brushless DC motor is a power source for operating a work tool (or an end tool)
Feature 3: the brushless DC motor includes multiple windings;
Feature 4: the brushless DC motor includes multiple terminals;
Feature 5: an inverter (or an inverter section);
Feature 6: the inverter includes multiple energization paths each coupling the multiple terminals to a DC power source;
Feature 7: the inverter includes multiple switching elements each provided on the multiple energization paths;
Feature 8: the inverter is configured to control energization (or power supply) and an energizing direction to the multiple windings via the multiple switching elements;
Feature 9: a control circuit (or a control section);
Feature 10: the control circuit is configured to execute a first operation, the first operation including switching a setting of a switch pattern pair at each commutation timing of the brushless DC motor, the switch pattern pair including a first pattern and a second pattern, each of the first pattern and the second pattern specifying ON/OFF states of the multiple switching elements for energizing the multiple windings via the inverter, the “ON/OFF state” meaning a state of being turned either ON or OFF;
Feature 11: the ON/OFF state of the first pattern differs from the ON/OFF state of the second pattern;
Feature 12: the control circuit is configured to execute a second operation, the second operation including alternately switching a setting of a switch pattern between the first pattern and the second pattern corresponding to the switch pattern pair that is set, in synchronization with a PWM control cycle;
Feature 13: the control circuit is configured to execute a third operation, the third operation including executing PWM control of an energization current (or a supply current) to the multiple windings in synchronization with the PWM control cycle, “PWM” standing for Pulse Width Modulation;
Feature 14: the third operation includes turning each of the multiple switching elements ON or OFF in accordance with the switch pattern switched by the second operation;
Feature 15: the control circuit is configured to execute a fourth operation, the fourth operation including setting (or updating) the commutation timing based on a timing when a magnitude relationship between an inductance of a first energization path and an inductance of a second energization path is reversed, the first energization path being a path in the multiple windings through which a current from the DC power source flows when the switch pattern is set to the first pattern, and the second energization path being a path in the multiple windings through which a current from the DC power source flows when the switch pattern is set to the second pattern;
Feature 16: the fourth operation includes detecting (or updating) a rotational position of the brushless DC motor based on the timing when the magnitude relationship is reversed, wherein in Feature 15, the commutation timing may be set based on the rotational position having been detected (or updated) by Feature 16;
Feature 17: the control circuit is configured to execute a fifth operation;
Feature 18: the fifth operation includes detecting a load applied from the work tool to the brushless DC motor; and
Feature 19: the fifth operation includes setting a duty cycle (or duty ratio) of the PWM control based on the load, the duty cycle being (i) a ratio (or proportion) of a time during which the inverter is controlled in accordance with the first pattern to a length of the PWM control cycle, and/or (ii) a ratio (or proportion) of a time during which the inverter is controlled in accordance with the second pattern to the length of the PWM control cycle.

An electric work machine including at least Features 1 through 19 can (i) detect the rotational position without using a rotation sensor even during low-speed rotation, and/or (ii) rotate the brushless DC motor even if the load increases due to the work tool being replaced, thereby enabling detection of the rotational position.

As used herein, the term “energization path” refers to a path through which a current flows, and is synonymous with the term “current path.” The control circuit may include a motor rotational position detector (or a motor rotational position detection circuit) and/or a duty cycle setter (or a duty cycle setting circuit). The motor rotational position detector may be configured to execute the second through fourth operations. The duty cycle setter may be configured to execute the fifth operation.

The brushless DC motor may include a stator and a rotor. In this specification, the “rotational position” of the brushless DC motor may mean the rotational position of the rotor. More specifically, the “rotational position” may mean a rotation angle (e.g., an electrical angle) of the rotor.

The rotor may include multiple permanent magnets arranged along a circumferential direction. The brushless DC motor may be in the form of an interior permanent magnet synchronous motor. An interior permanent magnet synchronous motor is also referred to as an “IPMSM”.

The work tool may be configured to be removably attached to the electric work machine (or a main body of the electric work machine). Examples of the work tool include (i) a rotary blade configured to cut grass and small-diameter trees through rotation thereof, (ii) a fan configured to generate an airflow through rotation thereof, (iii) a hedge trimmer, and (iv) a ground trimmer.

The multiple windings may be provided on the stator. The multiple windings may include one or more sets of three-phase winding groups. Each of the one or more sets of three-phase winding groups includes three windings coupled to each other. The three windings may be delta-connected to each other or star-connected to each other.

The multiple terminals may include a first terminal, a second terminal, and a third terminal. The one or more sets of three-phase winding groups may be coupled to the first terminal, the second terminal, and/or the third terminal.

The inverter may be configured to receive DC power from a DC power source. An example of the DC power source includes a battery. The inverter may be configured to convert the DC power into three-phase power (i.e., three-phase voltage and three-phase current) and supply the three-phase power to the brushless DC motor. The three-phase power may be supplied to the brushless DC motor via the first through third terminals.

The inverter may include a three-phase bridge circuit. The three-phase bridge circuit may have three positive-side energization paths, three negative-side energization paths, and six switching elements. The six switching elements include three high-side switching elements (a first switching element, a second switching element, and a third switching element) and three low-side switching elements (a fourth switching element, a fifth switching element, and a sixth switching element).

The three positive-side energization paths may be configured to electrically couple the respective first through third terminals of the brushless DC motor to a positive electrode of the DC power source. The three negative-side energization paths may be configured to electrically couple the respective first through third terminals to a negative electrode of the DC power source.

The first through third switching elements may be (i) located on the three positive-side energization paths, respectively, and (ii) configured to establish or interrupt conduction in the three positive-side energization paths, respectively. The fourth through sixth switching elements may be (i) located on the three negative-side energization paths, respectively, and (ii) configured to establish or interrupt conduction in the three negative-side energization paths, respectively.

The first through sixth switching elements may be configured to receive first through sixth control signals, respectively. That is, the first through sixth switching elements may be turned ON or OFF upon receiving the first through sixth control signals, respectively.

Each of the first through sixth switching elements may be in the form of a semiconductor switch or a form different from a semiconductor switch. Examples of the semiconductor switch include a field-effect transistor (FET), a bipolar transistor, an insulated gate bipolar transistor (IGBT), a thyristor, and a solid-state relay (SSR).

Each of the first and second patterns may represent a combination of ON or OFF states of each of the multiple switching elements. In other words, each of the first and second patterns may represent a combination of multiple control signals (e.g., the first through sixth control signals) for turning ON or OFF the multiple switching elements. Each of the first and second patterns may represent two or three switching elements to be turned ON among the multiple switching elements. Each of the first and second patterns may represent two or three switching elements to be turned OFF among the multiple switching elements.

Both the first and second patterns enable the brushless DC motor (specifically, the rotor) to rotate (specifically, rotating in a prescribed direction). In other words, the first and second patterns are each configured to cause the brushless DC motor to generate rotational torque (specifically, rotational torque in the prescribed direction). The prescribed direction is a set or designated rotation direction. A user of the electric work machine may be able to designate the prescribed direction for the electric work machine.

Both the first and second patterns enable the brushless DC motor to rotate at least under no load. Each of the first and second patterns may be configured to cause the brushless DC motor to rotate when a load externally applied to the brushless DC motor is at or below a specific level.

The control circuit may be configured to alternately repeat control of the inverter in accordance with the first pattern (i.e., ON/OFF control of the multiple switching elements) and control in accordance with the second pattern at each control cycle. The duty cycle may be a proportion of time during which the control in accordance with the first pattern is performed within one cycle period, in a control cycle period in which the control in accordance with the first pattern is performed. The duty cycle may be a proportion of time during which the control in accordance with the second pattern is performed within one cycle period, in a control cycle period in which the control in accordance with the second pattern is performed. In other words, the duty cycle may be a proportion of time within one cycle period during which a current for generating rotational torque in the brushless DC motor is being supplied from the DC power source to the brushless DC motor.

Each of the multiple switching elements may include a diode. The diode may be coupled in parallel to the corresponding switching element. A diode corresponding to a high-side switching element (hereinafter referred to as a “high-side diode”) may be coupled such that a direction from the brushless DC motor toward the positive electrode of the DC power source is a forward direction. That is, the high-side diode may include an anode electrically coupled to the brushless DC motor and a cathode electrically coupled to the positive electrode of the DC power source. A diode corresponding to a low-side switching element (hereinafter referred to as a “low-side diode”) may be coupled such that a direction from the negative electrode of the DC power source toward the brushless DC motor is a forward direction. That is, the low-side diode may include an anode electrically coupled to the negative electrode of the DC power source and a cathode electrically coupled to the brushless DC motor. When each of the multiple switching elements is a metal-oxide-semiconductor field-effect transistor (MOSFET), a so-called body diode (or parasitic diode) included in the MOSFET corresponds to the diode.

Each of the first energization path and the second energization path may be defined as an energization path from one or two inflow terminals to one or two outflow terminals in the brushless DC motor. The inflow terminal is a terminal among the multiple terminals into which a current flows from the inverter. The outflow terminal is a terminal among the multiple terminals from which a current flows out to the inverter.

Each of the first energization path and the second energization path may be defined as a path through which a drive current for rotating the brushless DC motor flows. The drive current flows from the positive electrode of the DC power source to the negative electrode of the DC power source through the inverter and the brushless DC motor.

Here, the inductance of the first energization path is referred to as “first inductance”, and the inductance of the second energization path is referred to as “second inductance”.

The “magnitude relationship” may indicate which one is larger (or which one is smaller) in a relative comparison between the first inductance and the second inductance. The first inductance and the second inductance can be different from each other. Furthermore, the magnitude relationship between the inductances can change in accordance with the rotational position of the brushless DC motor.

For example, in response to the rotational position changing from a first range to a second range, the magnitude relationship between the inductances can change from a first relationship to a second relationship. The first relationship may be, for example, a relationship in which the second inductance is larger than the first inductance, and the second relationship may be, for example, a relationship in which the first inductance is larger than the second inductance.

Therefore, the rotational position can be detected (i.e., updated) based on the timing when the magnitude relationship between the inductances is reversed. Furthermore, the next commutation timing can be set based on the rotational position having been updated. The “next commutation timing” is a timing at which the switch pattern should be switched to a pattern corresponding to the updated new rotational position.

The “load” (specifically, for example, a magnitude of the load) may be detected in any manner. The electric work machine may include a detector that can detect the magnitude of the load. The control circuit may set the duty cycle based on the magnitude of the load detected by the detector in the fifth operation. For example, the control circuit may set the duty cycle to increase as the magnitude of the load increases.

The detector may be able to detect a physical quantity that indirectly indicates the magnitude of the load. In that case as well, the control circuit may set the duty cycle based on the detected physical quantity. For example, the control circuit may set the duty cycle to increase as the physical quantity increases (or decreases). The physical quantity may be, for example, the magnitude of the drive current or the rotational speed of the brushless DC motor.

An embodiment may include, in addition to or in place of at least one of Features 1 through 19, at least one of:
Feature 20: the control circuit is configured to execute a sixth operation, the sixth operation includes setting the commutation timing based on a back EMF (also referred to as an induced voltage), and the back EMF is generated in the multiple windings by rotation of the brushless DC motor;
Feature 21: the sixth operation includes turning each of the multiple switching elements ON or OFF in accordance with an energization pattern corresponding to the commutation timing set based on the back EMF, thereby executing the PWM control; and
Feature 22: the control circuit is configured to execute the first through fifth operations while bypassing the sixth operation based on the rotational speed of the brushless DC motor being at or below a termination rotational speed (or a rotational speed threshold).

The termination rotational speed may be preset. The control circuit may include a sensorless control section (or a sensorless control circuit). The sensorless control section may be configured to execute the sixth operation.

In an electric work machine including at least Features 1 through 22, the control circuit is configured to execute the sixth operation. However, when the rotational speed is at or below the termination rotational speed, the control circuit sets the commutation timing based on the first through fifth operations. That is, which of the first through fifth operations or the sixth operation is executed depends on the rotational speed of the brushless DC motor (depending on whether the rotational speed of the brushless DC motor is at or below the termination rotational speed).

When the rotational speed is at or below the termination rotational speed, it is impossible or difficult to properly detect the rotational position from the back EMF. In this case, by executing the first through fifth operations, it is possible to detect the rotational position and drive the brushless DC motor. Hereinafter, driving the brushless DC motor based on the first through fifth operations is referred to as “twin-pulse drive.”

When the rotational speed exceeds the termination rotational speed, the rotational position can be detected from the back EMF. In this case, the drive method of the brushless DC motor can be switched from the twin-pulse drive to a drive based on the sixth operation (i.e., general sensorless drive). Therefore, when the brushless DC motor is rotating at high speed, it is not necessary to perform the twin-pulse drive. This can reduce the control load on the control circuit during high-speed rotation.

An embodiment may include, in addition to or in place of at least one of Features 1 through 22, at least one of:
Feature 23: the fifth operation includes setting the duty cycle such that the magnitude of the current flowing through the brushless DC motor while the third operation is being executed maintains a current target (or a desired level, a desired current, a desired current value, or a desired current range), wherein the fifth operation may include detecting the magnitude of the current, detecting the magnitude of the current corresponding to detecting the load applied to the brushless DC motor; and
Feature 24: the current target is set such that the brushless DC motor is rotatable, wherein the current target may be a specific current value or a range of current values having a specific width.

An embodiment may include, in addition to or in place of at least one of Features 1 through 24, at least one of:
Feature 25: a permissible current range is set as the current target;
Feature 26: the fifth operation includes increasing or decreasing the duty cycle such that the magnitude of the current is maintained within the permissible current range; and
Feature 27: the permissible current range is between a desired current lower limit (or lower limit current) and a desired current upper limit (or upper limit current), the desired current upper limit being larger than the desired current lower limit.

In an electric work machine including at least Features 1 through 20 and 23 through 27, the duty cycle during the twin-pulse drive is controlled based on the magnitude of the current (e.g., the current value) flowing through the brushless DC motor. This allows the duty cycle to be easily controlled. Also, the duty cycle is increased or decreased such that the current value is maintained within the permissible current range. Therefore, the rotational torque of the brushless DC motor can be controlled to a desired torque, whereby the rotational speed can be more reliably increased to a desired rotational speed.

An embodiment may include, in addition to or in place of at least one of Features 1 through 27, at least one of:
Feature 28: the fifth operation includes increasing the current target stepwise at every target update cycle, wherein the target update cycle may be a constant cycle; and
Feature 29: the target update cycle is longer than the PWM control cycle.

In an electric work machine including at least Features 1 through 19, 23, 24, 28, and 29, the rotational speed can be gradually increased after the twin-pulse drive is started. This allows the brushless DC motor to be started stably.

An embodiment may include, in addition to or in place of at least one of Features 1 through 29, at least one of:
Feature 30: the third operation includes alternately generating a first drive period and a second drive period in synchronization with the PWM control cycle;
Feature 31: the first drive period includes a first energization period and a first forced-decay period after the first energization period;
Feature 32: the second drive period includes a second energization period and a second forced-decay period after the second energization period;
Feature 33: the third operation includes controlling the multiple switching elements (specifically turning them ON or OFF) in accordance with a first pattern in the first energization period, wherein the first pattern may be referred to as a “first main pattern”;
Feature 34: the third operation includes controlling the multiple switching elements (specifically turning them ON or OFF) in accordance with a first forced-decay pattern in the first forced-decay period;
Feature 35: the third operation includes controlling the multiple switching elements (specifically turning them ON or OFF) in accordance with a second pattern in the second energization period, wherein the second pattern may be referred to as a “second main pattern”;
Feature 36: the third operation includes controlling the multiple switching elements (specifically turning them ON or OFF) in accordance with a second forced-decay pattern in the second forced-decay period;
Feature 37: the first forced-decay pattern is set to apply a DC voltage of the DC power source to the brushless DC motor via the inverter, thereby causing at least a portion of first magnetic energy to be discharged externally from the brushless DC motor, the first magnetic energy being accumulated in the multiple windings during the first energization period;
Feature 38: the second forced-decay pattern is set to apply the DC voltage to the brushless DC motor via the inverter, thereby causing at least a portion of second magnetic energy to be discharged externally from the brushless DC motor, the second magnetic energy being accumulated in the multiple windings during the second energization period; and
Feature 39: each of (i) a ratio of a length of the first energization period to a length other than the first energization period in the first drive period, and (ii) a ratio of a length of the second energization period to a length other than the second energization period in the second drive period, corresponds to the duty cycle.

In an electric work machine including at least Features 1 through 19 and 30 through 39, the first magnetic energy can be forcibly (i.e., actively and/or quickly) decayed in the first forced-decay period, and the second magnetic energy can be forcibly decayed in the second forced-decay period. This allows the brushless DC motor to rotate stably in a low-speed rotation range. Also, the rotational speed can be stably increased in the low-speed rotation range.

An embodiment may include, in addition to or in place of at least one of Features 1 through 39,
Feature 40: the first forced-decay pattern and the second forced-decay pattern are set such that a regenerative current flows from the brushless DC motor to the positive electrode of the DC power source via the inverter.

In an electric work machine including at least Features 1 through 19 and 30 through 40, the first and second magnetic energies can be more quickly decayed. In other words, an amount of magnetic energy discharged per unit time can be further increased.

An embodiment may include, in addition to or in place of at least one of Features 1 through 40,
Feature 41: the first forced-decay pattern is set to control ON/OFF states of the multiple switching elements when the multiple switching elements in accordance with the first forced-decay pattern are opposite to the ON/OFF states when the multiple switching elements are controlled in accordance with the first pattern.

In an electric work machine including at least Features 1 through 19, 30 through 39, and 41, the first magnetic energy can be more quickly and efficiently decayed.

An embodiment may include, in addition to or in place of at least one of Features 1 through 41,
Feature 42: the second forced-decay pattern is set to control ON/OFF states of the multiple switching elements when the multiple switching elements in accordance with the second forced-decay pattern are opposite to the ON/OFF states when the multiple switching elements are controlled in accordance with the second pattern.

In an electric work machine including at least Features 1 through 19, 30 through 39, and 42, the second magnetic energy can be more quickly and efficiently decayed.

An embodiment may include, in addition to or in place of at least one of Features 1 through 42,

Feature 43: a length of the first energization period, a length of the first forced-decay period, a length of the second energization period, and a length of the second forced-decay period are set such that an average value of a drive current in a pair period is less than 30% (or less than 30% and greater than 0%) of a peak value of the drive current in the pair period, the pair period being a consecutive period of one first drive period and one second drive period, the drive current being a current flowing between the DC power source and the brushless DC motor via the inverter.

An embodiment may include, in addition to or in place of at least one of Features 1 through 43,

Feature 44: the length of the first energization period, the length of the first forced-decay period, the length of the second energization period, and the length of the second forced-decay period are set such that an average value of a forward-direction phase current in the pair period is less than 80% (or less than 80% and greater than 0%) of a peak value of the forward-direction phase current in the pair period, the forward-direction phase current being a current, among multiple currents each flowing through a corresponding one of the multiple terminals, that flows in a direction of flowing from the inverter into the brushless DC motor in both the first energization period and the second energization period.

In an electric work machine including at least Features 1 through 19, 30 through 39, and 43, and an electric work machine including at least Features 1 through 19, 30 through 39, and 44, the average value of the rotational torque in the entire pair period can be reduced while properly ensuring the peak value of the drive current and/or the peak value of the forward-direction phase current (i.e., ensuring the rotational torque necessary for increasing the rotational speed). This can moderate an excessive increase in the rotational speed in the low-speed rotation range.

If the average value of the drive current is 30% or more of the peak value of the drive current, excessive rotational torque may be generated, which may lead to an excessive increase in the rotational speed. In contrast, by setting the length of each period such that the average value of the drive current is less than 30% of the peak value of the drive current, generation of excessive rotational torque can be inhibited or avoided.

Similarly, if the average value of the forward-direction phase current is 80% or more of the peak value of the forward-direction phase current, excessive rotational torque may be generated, which may lead to an excessive increase in the rotational speed. In contrast, by setting the length of each period such that the average value of the forward-direction phase current is less than 80% of the peak value of the forward-direction phase current, generation of excessive rotational torque can be inhibited or avoided.

An embodiment may include, in addition to or in place of at least one of Features 1 through 44, at least one of:
Feature 45: the first drive period includes a first freewheeling period after the first forced-decay period;
Feature 46: the third operation includes controlling the multiple switching elements (specifically turning them ON or OFF) in accordance with a first freewheeling pattern in the first freewheeling period; and
Feature 47: the first freewheeling pattern is set to form a first closed circuit for allowing a freewheeling current based on the first magnetic energy to flow, the first closed circuit including the brushless DC motor and the inverter and not including the DC power source.

In an electric work machine including at least Features 1 through 19, 30 through 39, and 45 through 47, the average value of the rotational torque in the first drive period can be maintained at an appropriate level.

An embodiment may include, in addition to or in place of at least one of Features 1 through 47, at least one of:
Feature 48: the second drive period includes a second freewheeling period after the second forced-decay period;
Feature 49: the third operation includes controlling the multiple switching elements (specifically turning them ON or OFF) in accordance with a second freewheeling pattern in the second freewheeling period; and
Feature 50: the second freewheeling pattern is set to form a second closed circuit for allowing a freewheeling current based on the second magnetic energy to flow, the second closed circuit including the brushless DC motor and the inverter and not including the DC power source.

In an electric work machine including at least Features 1 through 19, 30 through 39, and 48 through 50, the average value of the rotational torque in the second drive period can be maintained at an appropriate level.

Each of the first closed circuit and the second closed circuit may include at least one of multiple diodes each coupled in parallel to one of the multiple switching elements.

An embodiment may include, in addition to or in place of at least one of Features 1 through 50,
Feature 51: the length of the first forced-decay period is equal to the length of the second forced-decay period in a pair period, which is a consecutive period of one first drive period and one second drive period.

In an electric work machine including at least Features 1 through 19, 30 through 39, and 51, it is possible to moderate a decrease in detection accuracy of the reversal of the magnitude relationship due to a difference between a drive current decay amount in the first forced-decay period and a drive current decay amount in the second forced-decay period.

An embodiment may include, in addition to or in place of at least one of Features 1 through 51,
Feature 52: in the first drive period, the length of the first forced-decay period is set to increase as the length of the first energization period increases.

In an electric work machine including at least Features 1 through 19, 30 through 39, and 52, the length of the first forced-decay period is set to an appropriate length in accordance with the amount of the first magnetic energy. Therefore, it is possible to achieve both ensuring an appropriate peak value of the drive current and inhibiting excessive rotational torque in the first drive period.

An embodiment may include, in addition to or in place of at least one of Features 1 through 52,
Feature 53: in the second drive period, the length of the second forced-decay period is set to increase as the length of the second energization period increases.

In an electric work machine including at least Features 1 through 19, 30 through 39, and 53, the length of the second forced-decay period is set to an appropriate length in accordance with the amount of the second magnetic energy. Therefore, it is possible to achieve both ensuring an appropriate peak value of the drive current and inhibiting excessive rotational torque in the second drive period.

An embodiment may include, in addition to or in place of at least one of Features 1 through 53, at least one of:
Feature 54: the control circuit includes a processor;
Feature 55: the processor is configured to execute a part or all of the first, second, fourth, and fifth operations;
Feature 56: the control circuit includes a timer (or a timer circuit or a timer unit) configured to execute a part or all of the third operation;
Feature 57: the timer is hardware provided separately from the processor;
Feature 58: the timer is configured to be started by the processor;
Feature 59: the timer is configured to repeat counting from an initial value to a count target value in response to being started by the processor;
Feature 60: each of the first drive period and the second drive period corresponds to a period from the initial value to the count target value;
Feature 61: the timer is configured to execute a first operation, the first operation including outputting a control signal for controlling the multiple switching elements in accordance with the first pattern while a count variable (or a count value or a measured time value) of the timer is in a range corresponding to the first energization period;
Feature 62: the timer is configured to execute a second operation, the second operation including outputting the control signal for controlling the multiple switching elements in accordance with the first forced-decay pattern while the count variable of the timer is in a range corresponding to the first forced-decay period;
Feature 63: the timer is configured to execute a third operation, the third operation including outputting the control signal for controlling the multiple switching elements according to the second pattern while the count variable of the timer is in a range corresponding to the second energization period; and
Feature 64: the timer is configured to execute a fourth operation, the fourth operation including outputting the control signal for controlling the multiple switching elements in accordance with the second forced-decay pattern while the count variable of the timer is in a range corresponding to the second forced-decay period.

In an electric work machine including at least Features 1 through 19, 30 through 39, and 54 through 64, the load on the processor can be reduced. Also, execution timing of the control of the inverter in accordance with each pattern can be maintained with high precision.

An embodiment may include, in addition to or in place of at least one of Features 1 through 64 at least one of:
Feature 65: the fourth operation includes detecting the rotational position of the brushless DC motor and setting the commutation timing at a timing when a magnitude relationship between a first level and a second level is reversed, the first level indicating a magnitude of a current that has flowed through the first energization path in a first energization period, and the second level indicating a magnitude of a current that has flowed through the second energization path in a second energization period following the first energization period;
Feature 66: the first energization period is a period during which the multiple switching elements are controlled in accordance with the first pattern; and
Feature 67: the second energization period is a period during which the multiple switching elements are controlled in accordance with the second pattern.

In an electric work machine including at least Features 1 through 19 and 65 through 67, the rotational position can be easily and properly detected and the commutation timing can be properly set based on the first and second levels.

The first level is related to the first inductance. That is, the larger the first inductance, the smaller the first level. The second level is related to the second inductance. That is, the larger the second inductance, the smaller the second level. Therefore, when the magnitude relationship between the first inductance and the second inductance is reversed, the magnitude relationship between the first level and the second level is also reversed. Therefore, the rotational position can be properly detected and the commutation timing can be properly set based on the first level and the second level without directly measuring or obtaining the first and second inductances.

### 2. Specific Example Embodiment

Some example embodiments of the present disclosure will be described below with reference to the drawings.

### 2-1. First Embodiment

### [2-1-1. Configuration of Electric Work Machine]

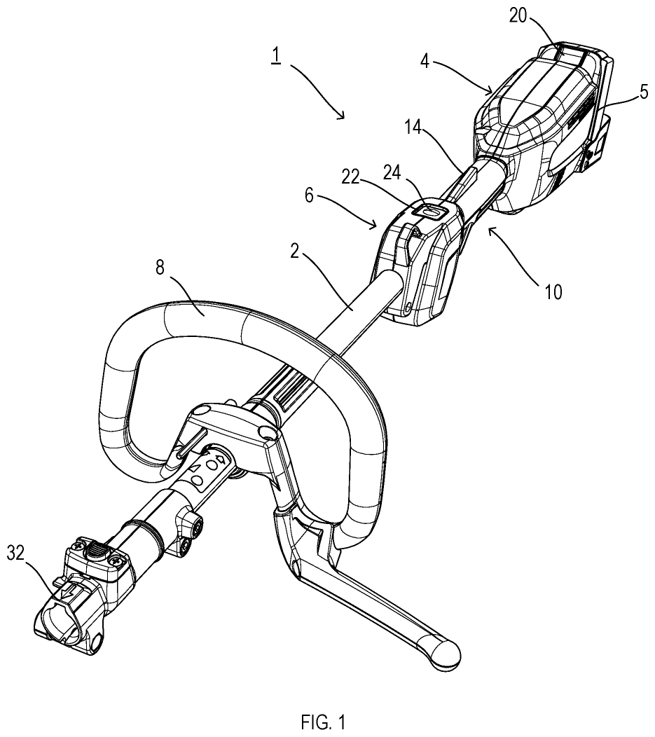

As shown in FIG. 1, an electric work machine 1 of a first embodiment includes a main pipe 2, a drive unit 4, a control section 6, and a handle 7. The main pipe 2 is formed in a long and hollow rod shape. The drive unit 4 is provided at a rear-end side of the main pipe 2.

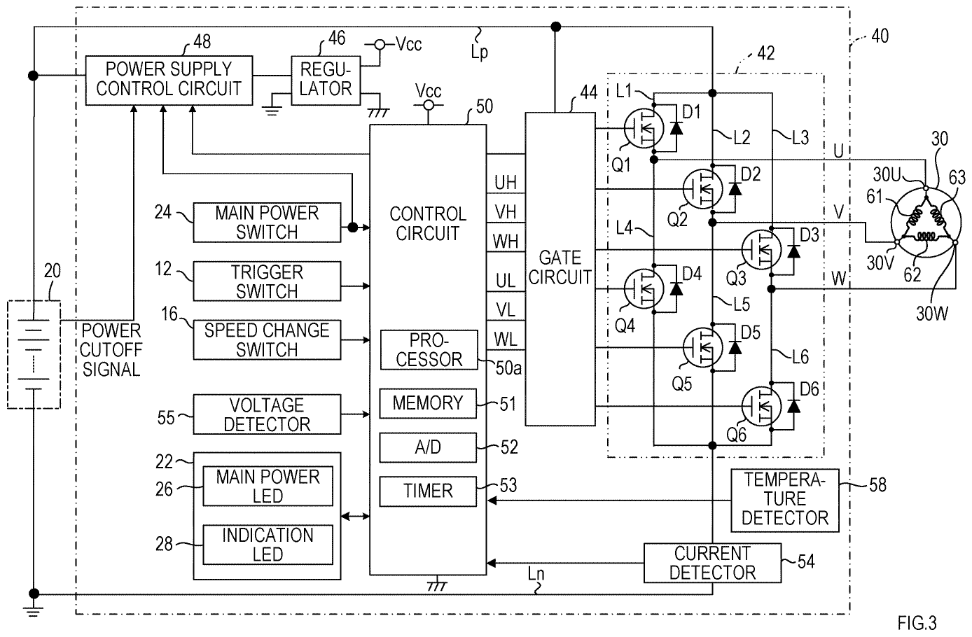

The drive unit 4 includes a motor 30 (see FIG. 3) and a gear mechanism (not shown). The motor 30 is a drive source of the electric work machine 1. The gear mechanism transmits rotation of the motor 30 (more specifically, rotational force or rotational torque) to an output shaft (not shown). The output shaft is inserted into the main pipe 2. The electric work machine 1 includes a battery mounting portion 5 at a rear-end side of the drive unit 4. The battery mounting portion 5 is configured such that a battery pack 20 is removably mounted thereto.

The motor 30 includes a rotor (not shown) and a stator (not shown). The rotor includes multiple magnets. The multiple magnets are embedded within the rotor (more specifically, within a rotor core). That is, the motor 30 of the first embodiment is an Interior Permanent Magnet (IPM) type three-phase brushless DC motor. The stator includes a first winding 61, a second winding 62, and a third winding 63 (see FIG. 3). Specifically, supply of electric power (or current) from an inverter 42 to the motor 30 means that electric power (or current) is supplied from the inverter 42 to the first through third windings 61 through 63. By supplying electric power to the first through third windings 61 through 63, the rotor generates rotational torque (or output torque), allowing the rotor to rotate. In the following description, “motor windings” refer to the first through third windings 61 through 63.

The control section 6 is disposed on the rear-end side of the main pipe 2 and forward of the drive unit 4. The control section 6 houses a controller 40 (see FIG. 3) for driving and controlling the motor 30.

The electric work machine 1 includes an operation section 10 between the drive unit 4 and the control section 6 in the main pipe 2 (hereinafter referred to as a “grip portion”). A user of the electric work machine 1 can operate (e.g., manually operate) the operation section 10 while holding the grip portion. The operation section 10 includes a trigger switch 12 (see FIG. 3) and a lock-off switch 14. The trigger switch 12 is pulled by the user. The trigger switch 12 is turned ON when the trigger switch 12 is pulled. The lock-off switch 14 is manually operated (e.g., pressed) by the user. By manually operating the lock-off switch 14, the trigger switch 12 becomes operable.

The operation section 10 includes a speed change switch 16 (see FIG. 3). The speed change switch 16 is operated by the user to adjust a rotational speed of the motor 30. The trigger switch 12 is provided to input a drive command for the motor 30 to the electric work machine 1.

An operation panel 22 is provided on the control section 6. The operation panel 22 includes a main power switch 24, a main power LED 26, and an indication LED 28 (see FIG. 3). The main power switch 24 is provided to enable or disable power supply from the battery pack 20 to the controller 40. The main power LED 26 displays an ON/OFF state of the main power switch 24 and an operating state of the electric work machine 1. The color of light emitted from the main power LED 26 and the lighting pattern of the main power LED 26 can change in accordance with the operating state of the electric work machine 1. The color of light emitted from the indication LED 28 and the lighting pattern of the indication LED 28 can change in accordance with the operating state of the electric work machine 1. Therefore, the user can identify the operating state of the electric work machine 1 by looking at the main power LED 26 and/or the indication LED 28.

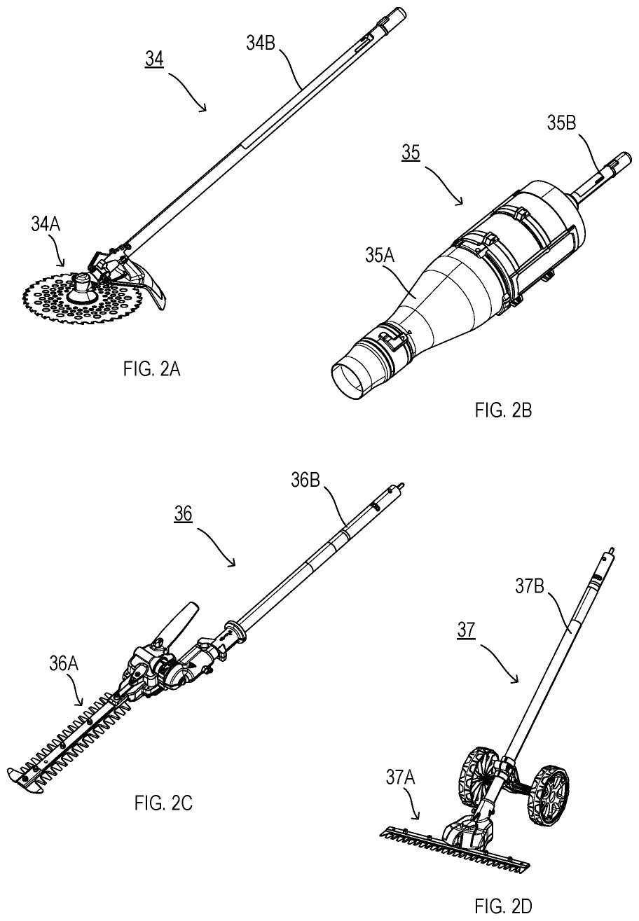

The electric work machine 1 includes a work unit mounting portion 32 at a front-end side of the main pipe 2. Work units 34, 35, 36, and 37 shown in FIGS. 2A through 2D are selectively and removably mounted to the work unit mounting portion 32.

The work unit mounting part 32 serves to couple the output shaft within the main pipe 2 to rotation shafts (not shown) within pipes 34B, 35B, 36B, and 37B of the work units 34 through 37 by mounting the pipes 4B through 37B to a distal end of the main pipe 2. Therefore, when the pipes 34B through 37B of the work units 34 through 37 are mounted to the distal end of the main pipe 2, the rotation of the motor 30 can be transmitted to the rotation shafts of the work units 34 through 37.

Work tools 34A, 35A, 36A, and 37A are mounted on distal ends of the pipes 34B, 35B, 36B, and 37B of the work units 34 through 37, respectively. Each of the work tools 34A through 37A is driven by rotation of the rotation shafts within the pipes 34B through 37B. Therefore, the electric work machine 1 of the first embodiment can drive the work tools 34A through 37A of various work units 34 through 37 mounted on the distal end of the main pipe 2.

The work unit 34 shown in FIG. 2A includes the pipe 34B. Inside the pipe 34B, the rotation shaft (not shown) is rotatably arranged. In the work unit 34, the work tool 34A is removably mounted on one end side of the pipe 34B. The work tool 34A is a rotary blade for cutting objects to be cut, such as grass or small-diameter trees. The other end of the pipe 34B is removably mounted to the work unit mounting portion 32. When the pipe 34B is mounted to the work unit mounting portion 32, the rotation shaft is mechanically coupled to the output shaft. Thereby, the rotational force of the motor 30 is transmitted to the rotary blade via the output shaft and the rotation shaft, and the rotary blade is rotated. By rotating the rotary blade, mowing work can be performed.

The work unit 35 shown in FIG. 2B includes the pipe 35B. Inside the pipe 35B, the rotation shaft (not shown) is rotatably arranged. In the work unit 35, the work tool 35A is removably mounted on one end side of the pipe 35B. The work tool 35A is a blower having a built-in fan for blowing air. The other end of the pipe 35B is removably mounted to the work unit mounting portion 32. When the pipe 35B is mounted to the work unit mounting portion 32, the rotation shaft is mechanically coupled to the output shaft. Thereby, the rotational force of the motor 30 is transmitted to the fan via the output shaft and the rotation shaft, and the fan is rotated. When the fan is rotated, an air current is generated, which can blow away debris or the like. That is, the electric work machine 1 in this case can function as a blower.

The work unit 36 shown in FIG. 2C includes the pipe 36B. Inside the pipe 36B, the rotation shaft (not shown) is rotatably arranged. In the work unit 36, the work tool 36A is removably mounted on one end side of the pipe 36B. The work tool 36A is a trimmer for hedges (hedge trimmer). The other end of the pipe 36B is removably mounted to the work unit mounting portion 32. When the pipe 36B is mounted to the work unit mounting portion 32, the rotation shaft is mechanically coupled to the output shaft. Thereby, the rotational force of the motor 30 is transmitted to the hedge trimmer via the output shaft and the rotation shaft, and the hedge trimmer is driven. By driving the hedge trimmer, the work of trimming hedge branches and leaves can be performed.

The work unit 37 shown in FIG. 2D includes the pipe 37B. Inside the pipe 37B, the rotation shaft (not shown) is rotatably arranged. In the work unit 37, the work tool 37A is removably mounted on one end side of the pipe 37B. The work tool 37A is a ground trimmer configured to cut plants existing at a low position (e.g., grass). When the pipe 37B is mounted to the work unit mounting portion 32, the rotation shaft is mechanically coupled to the output shaft. Thereby, the rotational force of the motor 30 is transmitted to the ground trimmer via the output shaft and the rotation shaft, and the ground trimmer is driven. By driving the ground trimmer, cutting work can be performed.

The handle 8 is gripped by the user. The user can perform various types of work using the electric work machine 1 while gripping the handle 8. The handle 8 of the first embodiment has a loop shape. The handle 8 is fixed to the main pipe 2 between the work unit mounting portion 32 and the control section 6 such that the user can easily grip the handle 8.

The controller 40 is configured to (i) receive power supply from the battery pack 20 and (ii) drive and control the motor 30. As shown in FIG. 3, the controller 40 includes the inverter 42, a gate circuit 44, a regulator 46, a power supply control circuit 48, and a control circuit 50. The controller 40 directly controls the inverter 42, thereby indirectly controlling the motor 30.

The inverter 42 receives power supply from the battery pack 20 and supplies current to the motor 30 (more specifically, to the motor windings). In the first embodiment, the inverter 42 is in the form of a three-phase full-bridge circuit including first through sixth switching elements Q1 through Q6.

The motor 30 includes a first terminal 30U, a second terminal 30V, and a third terminal 30W. Inside the motor 30, the first terminal 30U is coupled to a first end of the first winding 61 and a second end of the third winding 63. Inside the motor 30, the second terminal 30V is coupled to a second end of the first winding 61 and a first end of the second winding 62. Inside the motor 30, the third terminal 30W is coupled to a second end of the second winding 62 and a first end of the third winding 63. The motor 30 receives power (hereinafter referred to as “drive power”) from the battery pack 20 via the inverter 42 and the first through third terminals 30U, 30V, and 30W, and rotates by the drive power.

The electric work machine 1 includes a positive electrode line (or power supply line) Lp and a negative electrode line Ln. The electric work machine 1 includes a positive electrode terminal (not shown) and a negative electrode terminal (not shown). When the battery pack 20 is mounted to the electric work machine 1, the positive electrode terminal is coupled to a positive electrode of the battery pack 20, and the negative electrode terminal is coupled to a negative electrode of the battery pack 20.

The positive electrode line Lp extends from the positive electrode terminal to the inverter 42. The negative electrode line Ln extends from the negative electrode terminal to the inverter 42.

The inverter 42 includes a first positive-side energization path L1, a second positive-side energization path L2, and a third positive-side energization path L3. A first end of the first positive-side energization path L1 is coupled to the positive electrode line Lp, and the other end of the first positive-side energization path L1 is coupled to the first terminal 30U. A first end of the second positive-side energization path L2 is coupled to the positive electrode line Lp, and the other end of the second positive-side energization path L2 is coupled to the second terminal 30V. A first end of the third positive-side energization path L3 is coupled to the positive electrode line Lp, and the other end of the third positive-side energization path L3 is coupled to the third terminal 30W.

The inverter 42 includes a first negative-side energization path L4, a second negative-side energization path L5, and a third negative-side energization path L6. A first end of the first negative-side energization path L4 is coupled to the negative electrode line Ln, and the other end of the first negative-side energization path L4 is coupled to the first terminal 30U. A first end of the second negative-side energization path L5 is coupled to the negative electrode line Ln, and the other end of the second negative-side energization path L5 is coupled to the second terminal 30V. A first end of the third negative-side energization path L6 is coupled to the negative electrode line Ln, and the other end of the third negative-side energization path L6 is coupled to the third terminal 30W.

The inverter 42 includes first through third switching elements Q1 through Q3 respectively provided on the first through third positive-side energization paths L1 through L3. Each of the first through third switching elements Q1 through Q3 functions as a so-called high-side switch. The first through third switching elements Q1 through Q3 respectively establish or interrupt conduction in the first through third positive-side energization paths L1 through L3. When the first through third switching elements Q1 through Q3 are turned on, the first through third positive-side energization paths L1 through L3 are conducted, respectively, and when the first through third switching elements Q1 through Q3 are turned off, the first through third positive-side energization paths L1 through L3 are interrupted, respectively. The first terminal 30U, the second terminal 30V, and the third terminal 30W correspond to U-phase, V-phase, and W-phase of the motor 30, respectively.

The inverter 42 includes fourth through sixth switching elements Q4 through Q6 respectively provided on the first through third negative-side energization paths L4 through L6. Each of the fourth through sixth switching elements Q4 through Q6 functions as a so-called low-side switch. The first through sixth switching elements Q4 through Q6 respectively establish or interrupt conduction in the first through third negative-side energization paths L4 through L6, respectively. When the fourth through sixth switching elements Q4 through Q6 are turned on, the first through third negative-side energization paths L4 through L6 are conducted, respectively, and when the fourth through sixth switching elements Q4 through Q6 are turned off, the first through third negative-side energization paths L4 through L6 are interrupted, respectively.

In the first embodiment, each of the first through sixth switching elements Q1 through Q6 is in the form of an n-channel metal-oxide-semiconductor field-effect transistor (MOSFET). Therefore, first through sixth diodes D1 through D6 are coupled in parallel to the first through sixth switching elements Q1 through Q6, respectively. Each of the first through sixth diodes D1 through D6 is a so-called parasitic diode. Each of the first through sixth diodes D1 through D6 is coupled between drain and source of the corresponding switching element such that a direction from the source toward the drain is a forward direction.

Each of the first through sixth diodes D1 through D6 can propagate a current in the forward direction when the corresponding switching element is in an OFF state.

The gate circuit 44 individually turns on/off the first through sixth switching elements Q1 through Q6 in accordance with first through sixth control signals UH, VH, WH, UL, VL, and WL output from the control circuit 50. By driving the inverter 42 in accordance with the first through sixth control signals UH, VH, WH, UL, VL, and WL, power is supplied to the motor 30, and the motor 30 can be rotated.

The first through third control signals UH, VH, and WH are control signals for driving the first through third switching elements Q1 through Q3, respectively. The fourth through sixth control signals UL, VL, and WL are control signals for driving the fourth through sixth switching elements Q4 through Q6, respectively. In the first embodiment, each of the first through sixth control signals UH, VH, WH, UL, VL, and WL is in the form of a binary signal. That is, each of the first through sixth control signals UH, VH, WH, UL, VL, and WL is set to an L (Low) level or an H (High) level. Each of the first through sixth switching elements Q1 through Q6 is turned off when the corresponding control signal is at one level (e.g., L level) and is turned on when the corresponding control signal is at the other level (e.g., H level).

The inverter 42 is controlled by the control circuit 50 and drives the motor 30 (i.e., controls energization and an energizing direction of the motor 30). The energizing direction refers to a direction of current flowing through each of the first through third terminals 30U, 30V, and 30W (e.g., direction of flowing into the motor 30 or flowing out from the motor 30 to the inverter 42).

The regulator 46 receives power supply from the battery pack 20 via the power supply control circuit 48. The regulator 46 generates, from the received power, a power supply voltage (DC constant voltage) Vcc for operation of each part in the controller 40. Each part in the controller 40, including the control circuit 50, operates by receiving the power supply voltage Vcc from the regulator 46.

When the main power switch 24 is in the ON state, the power supply control circuit 48 establishes conduction in the power supply path from the battery pack 20 to the regulator 46, causing the regulator 46 to generate the power supply voltage Vcc. When a power interruption signal is input from the battery pack 20 or the control circuit 50, the power supply control circuit 48 cuts off the power supply path from the battery pack 20 to the regulator 46 and stops generation of the power supply voltage Vcc by the regulator 46. The power interruption signal is output when an abnormality is detected in the battery pack 20 or the control circuit 50. Examples of abnormalities include a decrease in battery voltage.

The control circuit 50 controls the inverter 42 via the gate circuit 44, thereby driving and controlling the motor 30. The control circuit 50 in the first embodiment is in the form of a Micro Control Unit (MCU) including a processor 50a, a ROM, and a RAM. Examples of the processor 50a include a CPU. The control circuit 50 of the first embodiment includes a memory 51. The memory 51 is in the form of a non-volatile memory. The memory 51 is provided to store a state of an object to be controlled by the control circuit 50 (e.g., the inverter 42 and/or the motor 30) and a state of the controller 40. Part or all of the RAM may be included in the memory 51.

The control circuit 50 further includes an A/D converter 52 and a timer 53. The A/D converter 52 performs A/D conversion (i.e., conversion into digital data) on various analog signals (including a current detection signal described later). The timer 53 may be implemented in software or may be implemented as hardware separate from the processor 50a (e.g., a wired logic connection). The timer 53 in the first embodiment is hardware (timer unit) implemented separately from the processor 50a and may be referred to as a “hardware timer”. The timer 53 in the first embodiment has a function of measuring time. The timer 53 is configured to measure time by repeatedly counting from an initial value (e.g., zero) in a periodic manner. In a third embodiment described later, the timer 53 implements various functions in addition to the time measurement function.

In other embodiments, the control circuit 50 may include a combination of electronic components (e.g., discrete elements) instead of or in addition to the MCU, or may include an Application Specific Integrated Circuit (ASIC). The control circuit 50 may include an Application Specific Standard Product (ASSP), a programmable logic device such as a Field Programmable Gate Array (FPGA), or a combination thereof.

The control circuit 50 is coupled to the trigger switch 12, the speed change switch 16, and the operation panel 22. Therefore, the main power switch 24, the main power LED 26, and the indication LED 28 are also coupled to the control circuit 50.

The controller 40 includes a voltage detector 55, a current detector 54, and a temperature detector 58.

The voltage detector 55 is an electric circuit configured to detect various voltages. The various voltages include a battery voltage and voltages of the first through third terminals 30U, 30V, and 30W. The battery voltage is a voltage input from the battery pack 20 to the controller 40.

The current detector 54 is provided on the negative electrode line Ln. The electric work machine 1 may include a ground line coupled to the negative electrode terminal. The negative electrode line Ln may be directly coupled to the ground line and may be coupled to the negative electrode terminal via the ground line.

The current detector 54 is a circuit that detects a magnitude of a current (hereinafter referred to as “drive current”) Ib supplied from the battery pack 20 to the motor 30 via the inverter 42. Specifically, the current detector 54 outputs a current detection signal indicating the magnitude of the drive current Ib (hereinafter referred to as “drive current value”). The drive current Ib is converted into a three-phase current by the inverter 42. The three-phase current includes a U-phase current Iu, a V-phase current Iv, and a W-phase current Iw. The U-phase current Iu is input to the first terminal 30U, the V-phase current Iv is input to the second terminal 30V, and the W-phase current Iw is input to the third terminal 30W. In the first embodiment, for the three-phase currents Iu, Iv, and Iw, a direction from the inverter 42 toward the motor 30 is defined as positive, and a direction from the motor 30 toward the inverter 42 is defined as negative. For the drive current Ib, a direction from a positive electrode of the battery pack 20 through the inverter 42 and the motor 30 toward the negative electrode is defined as positive, and a direction from the negative electrode of the battery pack 20 through the inverter 42 and the motor 30 toward the positive electrode is defined as negative.

The temperature detector 58 is provided in the inverter 42 and detects temperatures of the first through sixth switching elements Q1 through Q6 (in other words, temperature of the inverter 42). The temperature detector 58 includes a temperature sensor. The temperature sensor may be, for example, a thermistor.

The control circuit 50 receives a corresponding detection signal from each of the voltage detector 55, the current detector 54, and the temperature detector 58.

### [2-1-2. Operation of Control Circuit]

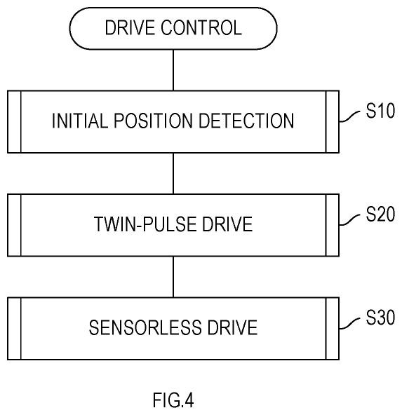

Next, a drive control process executed by the control circuit 50 (specifically, the processor 50a in the first embodiment) will be described with reference to FIG. 4.

The control circuit 50 starts the drive control process based on an input of a drive command from the trigger switch 12 (i.e., the trigger switch 12 being turned on), thereby driving the motor 30. When the drive control process is started, the control circuit 50 executes an initial position detection process in S10 (S represents a step). The initial position detection process is a process for detecting an initial position of the motor 30 (specifically, an initial position of the rotor). The initial position is a rotational position of the motor 30 (specifically, the rotational position of the rotor) before the motor 30 starts driving (i.e., while the motor 30 is stopped).

When the initial position of the motor 30 is detected in S10, the control circuit 50 executes a twin-pulse drive process in S20. In the twin-pulse drive process, energization to the motor 30 is started, whereby the rotational speed of the motor 30 increases. The twin-pulse drive process is executed until the rotational speed of the motor 30 reaches a preset termination rotational speed. The twin-pulse drive process is a process for increasing the rotational speed of the motor 30 to the termination rotational speed. The termination rotational speed indicates a timing at which the twin-pulse drive process should be terminated, in other words, a timing at which a sensorless drive process described later should be started. The termination rotational speed may be referred to as a “twin-pulse termination rotational speed”.

The termination rotational speed is a lower limit value of the rotational speed at which the energization to the motor 30 can be controlled based on a back EMF generated from the motor 30. The back EMF is generated in the motor windings as the motor 30 rotates. When the rotational speed of the motor 30 is higher than or equal to the termination rotational speed, the rotational position of the motor 30 can be detected based on the back EMF, and the energization to the motor 30 can be controlled based on the rotational position.

When the rotational speed of the motor 30 reaches the termination rotational speed by the twin-pulse drive process in S20, the process proceeds to S30. In S30, the control circuit 50 executes the sensorless drive process. The sensorless drive process includes detecting the rotational position of the motor 30 from the back EMF and controlling the energization to the motor 30 (directly controlling the inverter 42) based on the rotational position. In a region of the termination rotational speed or higher, the motor 30 is driven by the sensorless drive process.

### [2-1-3. Initial Position Detection Process]

The initial position detection process will be described in more detail. The initial position detection process is a process for detecting the rotational position (i.e., the aforementioned initial position) without rotating the motor 30 when the motor 30 is in a stopped state. In the first embodiment, the initial position detection process is executed in accordance with the procedure described in Japanese Unexamined Patent Application Publication No. H7-177788.

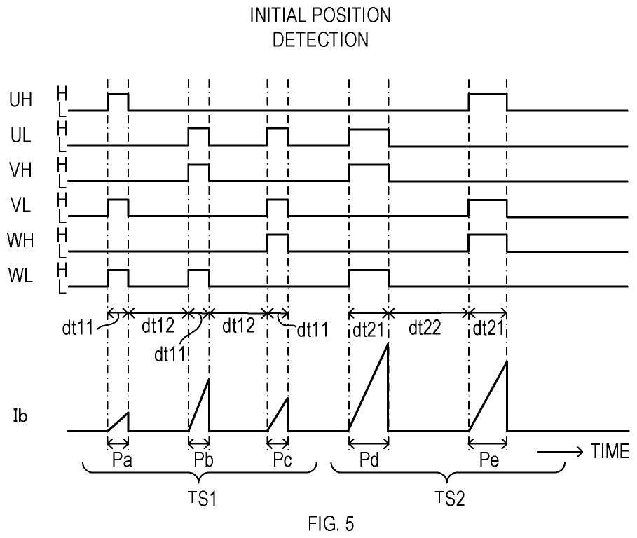

That is, in the first embodiment, as shown in FIG. 5, in the first step TS1, the control circuit 50 first outputs a preset control signal to sequentially apply the battery voltage for a certain time dt11 between terminals U-VW, V-WU, and W-UV of each phase U, V, and W of the motor 30. Specifically, as shown in FIG. 5, the battery voltage is applied between terminals U-VW during a period Pa, the battery voltage is applied between terminals V-WU during a period Pb, and the battery voltage is applied between terminals W-UV during a period Pc. Therefore, the drive current Ib in the period Pa corresponds to the U-phase current Iu, the drive current Ib in the period Pb corresponds to the V-phase current Iv, and the drive current Ib in the period Pc corresponds to the W-phase current Iw.

Then, the control circuit 50 detects a U-phase peak value, a V-phase peak value, and a W-phase peak value via the current detector 54. The U-phase peak value is a maximum value of the U-phase current Iu in the period Pa, the V-phase peak value is a maximum value of the V-phase current Iv in the period Pb, and the W-phase peak value is a maximum value of the W-phase current Iw in the period Pc. The control circuit 50 calculates the rotational position (electrical angle q) of the motor 30 from the detected U-phase peak value, V-phase peak value, and W-phase peak value using a specific approximation formula.

The time dt11 is set to a short time that does not cause magnetic saturation in the motor windings. After applying the battery voltage for the certain time dt11, the control circuit 50 stops the output of all control signals UH, VH, WH, UL, VL, and WL until a certain standby time dt12 has elapsed. In other words, part or all of the energy accumulated in the motor windings by energization is discharged during the standby time dt12.

As an example only, in the first embodiment, the rotational position is detected as a discrete value in steps of 60 degrees of electrical angle. That is, the rotational position detected in the first embodiment is any one of 60, 120, 180, 240, 300, and 360 degrees. Of course, the rotational position may be detected discretely in steps other than 60 degrees, or may be detected continuously.

In a first step TS1, the rotational position is not specified as one of the six rotational positions, but any one of three combinations is calculated. The three combinations include, for example, a first combination including 60 and 240 degrees, a second combination including 120 and 300 degrees, and a third combination including 180 and 360 degrees.

Therefore, in a second step TS2, one of the two rotational positions (i.e., one of the combinations) calculated in the first step TS1 is specified. Then, the specified one is determined as the initial position of the motor 30.

In the first step TS1, a combination corresponding to a maximum peak phase among the three combinations is calculated. The maximum peak phase is a phase corresponding to the largest value among the U-phase peak value, V-phase peak value, and W-phase peak value detected in the first step TS1. In the example of FIG. 5, the maximum peak phase is the V-phase. Accordingly, through the first step TS1, candidates for the initial position are narrowed down to one corresponding to the V-phase among the three combinations.

Thus, in the second step TS2, a forward current and a reverse current are sequentially supplied to the terminal corresponding to the maximum peak phase of the motor 30. Then, one of the two rotational positions calculated in the first step TS1 is determined as the initial position based on magnitude relationship between a magnitude of the forward current and a magnitude of the reverse current.

In the example of FIG. 5, the maximum peak phase detected in the first step TS1 is the V-phase. Therefore, in this case, first, in the period Pd, the battery voltage is applied between the terminals V-UL for a certain time dt21. This causes the V-phase current Iv to flow in the forward direction. Thereafter, in the period Pe after a specific time dt22 has elapsed, the battery voltage is applied between the terminals UL-V for the certain time dt21. This causes the V-phase current Iv to flow in the negative direction. Then, the maximum value of the drive current Ib in each of the periods Pd and Pe (i.e., the maximum value of the absolute value of the V-phase current Iv in each of the periods Pd and Pe) is detected. Based on the magnitude relationship between these two maximum values, the rotational position (electrical angle q) of the motor 30 is specified. That is, one of the candidates (two rotational positions) narrowed down by the first step TS1 is determined as the initial position.

As a result, in the initial position detection process, the rotational position of the motor 30 can be detected without rotating the motor 30. The detection procedure of the initial position shown in FIG. 5 is described in detail in the aforementioned Japanese Unexamined Patent Application Publication No. H7-177788, and thus the detailed description thereof is omitted here.

### [2-1-4. Sensorless Drive Process]

The sensorless drive process will be described in more detail. The sensorless drive process is performed in the same procedure as the high-speed mode described in Japanese Patent No. 7118699.

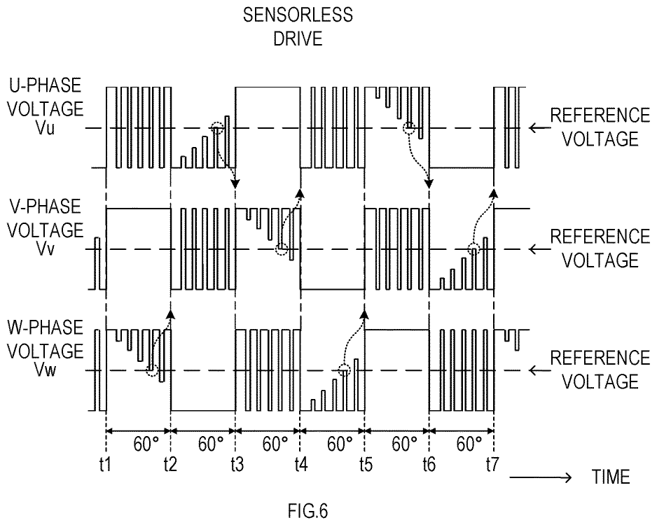

In the sensorless drive process, as shown in FIG. 6, one high-side switch and one low-side switch in the inverter 42 are sequentially selected in accordance with a preset energization pattern at every specific rotation angle (every 60 degrees of electrical angle) of a motor 30. Furthermore, one of the two selected switching elements is turned on, and the other switching element is turned on/off in accordance with a PWM signal. The PWM signal has a specific duty cycle.

As a result, energization to the motor windings and the energizing direction are switched at commutation timings, and the current flowing through the motor windings is PWM-controlled. A commutation timing occurs every time the motor 30 rotates by 60 degrees of electrical angle. Each of t1 through t7 in FIG. 6 indicates a commutation timing. For example, in the period from t1 through t2, a second switching element Q2 is turned on, and a sixth switching element Q6 is driven in accordance with the PWM signal.

When the energization to the motor 30 is controlled in this manner, every time the energization pattern is switched at the commutation timing, one of the first through third terminals 30U, 30V, and 30W enters an open state. A back EMF is generated at the terminal in the open state as the motor 30 rotates. This back EMF changes from the positive side to the negative side of the inverter 42, or vice versa. Therefore, the rotational position of the motor 30 can be identified by detecting the center of fluctuation of the back EMF. For example, in the period from t1 through t2 in FIG. 6, the third terminal 30W is in the open state, and a back EMF is generated at the third terminal 30W.

Therefore, a reference voltage is generated in the sensorless drive process. A magnitude of the reference voltage represents the center of fluctuation of the back EMF. In the first embodiment, the reference voltage is generated by dividing the power supply voltage (i.e., the battery voltage) by half. That is, the magnitude of the reference voltage is ½ of the power supply voltage. This reference voltage is compared with the back EMF obtained from the terminal in the open state.

Then, a timing at which the magnitude relationship between the reference voltage and the back EMF is inverted, i.e., a timing at which the back EMF crosses the reference voltage, is detected as a zero-cross point. The rotational position of the motor 30 is detected from the zero-cross point. The rotational position is detected at every specific rotation angle (i.e., every 60 degrees of electrical angle). As indicated by arrows in FIG. 6, commutation timings (t2 through t7 in FIG. 6) are determined based on the detection timing of the zero-cross point.

In the sensorless drive process of the first embodiment, as shown in FIG. 6, a positive or negative voltage is applied to each of the first through third terminals 30U, 30V, and 30W during an electrical angle of 120 degrees. However, in the latter half of the voltage application period (i.e., 120 degrees of electrical angle), the applied voltage is PWM-controlled. Thereby, the current supplied to the motor 30 is controlled.

### [2-1-5. Twin-Pulse Drive Process]

Next, the twin-pulse drive process will be described in detail. The twin-pulse drive process is basically performed in the same procedure as the low-speed mode described in Japanese Patent No. 7118699.

Specifically, in the control circuit 50, multiple switch pattern pairs used in the twin-pulse drive process, as exemplified in Table 1, are prepared. The multiple switch pattern pairs may be stored in advance in the memory 51.

Each of the multiple switch pattern pairs includes a first pattern and a second pattern. Both the first pattern and the second pattern are energization patterns for supplying power from the battery pack 20 to the motor 30. That is, both the first pattern and the second pattern are energization patterns that can generate rotational torque in the motor 30.

As shown in Table 1, in the first embodiment, two switch pattern pairs are prepared for each of six rotation angle ranges divided every 60 degrees of electrical angle. One of the two switch pattern pairs is used during forward rotation, and the other is used during reverse rotation. “Rotor Position” in Table 1 means the aforementioned rotational position.

TABLE 1

| | Switch Pattern Pair | | Switch Pattern Pair | |
|---|---|---|---|---|
| | (During Forward Rotation) | | (During Reverse Rotation) | |
| Rotor | First | Second | First | Second |
| Position | Pattern | Pattern | Pattern | Pattern |
| 0-60° | UL, VH, WL | UL, VH, WH | UH, VL, WH | UL, VL, WH |
| 60-120° | UL, VH, WH | UL, VL, WH | UH, VL, WL | UH, VL, WH |
| 120-180° | UL, VL, WH | UH, VL, WH | UH, VH, WL | UH, VL, WL |
| 180-240° | UH, VL, WH | UH, VL, WL | UL, VH, WL | UH, VH, WL |
| 240-300° | UH, VL, WL | UH, VH, WL | UL, VH, WH | UL, VH, WL |
| 300-360° | UH, VH, WL | UL, VH, WL | UL, VL, WH | UL, VH, WH |

Each pattern in Table 1 indicates three control signals to be set to an H level among six control signals. For example, the first pattern corresponding to the rotor position “120-180°” and forward rotation is “UL, VL, WH.” This first pattern “UL, VL, WH” indicates that the control signals UL, VL, and WH should be set to a high level and the other control signals UH, VH, and WL should be set to a low level. In other words, this first pattern “UL, VL, WH” indicates that third through fifth switching elements Q3 through Q5 should be turned on and first, second, and sixth switching elements Q1, Q2, and Q6 should be turned off.

The notation “X-Y” indicating the rotor position in Table 1 specifically means greater than X° and less than or equal to Y°. According to Table 1, for example, when the rotation direction is the forward direction and the rotational position is within the range of “0-60°” (i.e., greater than 0° and less than or equal to) 60°, “UL, VH, WL” and “UL, VH, WH” are used as the first and second patterns, respectively.

As a mere example, in the first embodiment, the rotational position is detected with a resolution of 60° electrical angle as described above. Specifically, any one of 60°, 120°, 180°, 240°, 300°, and 360° (i.e., 0°) is detected as the rotational position. While the rotational position of 60° is being detected, a switch pattern pair corresponding to “0-60°” is set. While the rotational position of 120° is being detected, a switch pattern pair corresponding to “60-120°” is set. While the rotational position of 180° is being detected, a switch pattern pair corresponding to “120-180°” is set. While the rotational position of 240° is being detected, a switch pattern pair corresponding to “180-240°” is set. While the rotational position of 300° is being detected, a switch pattern pair corresponding to “240-300°” is set. While the rotational position of 360° is being detected, a switch pattern pair corresponding to “300-360°” is set.

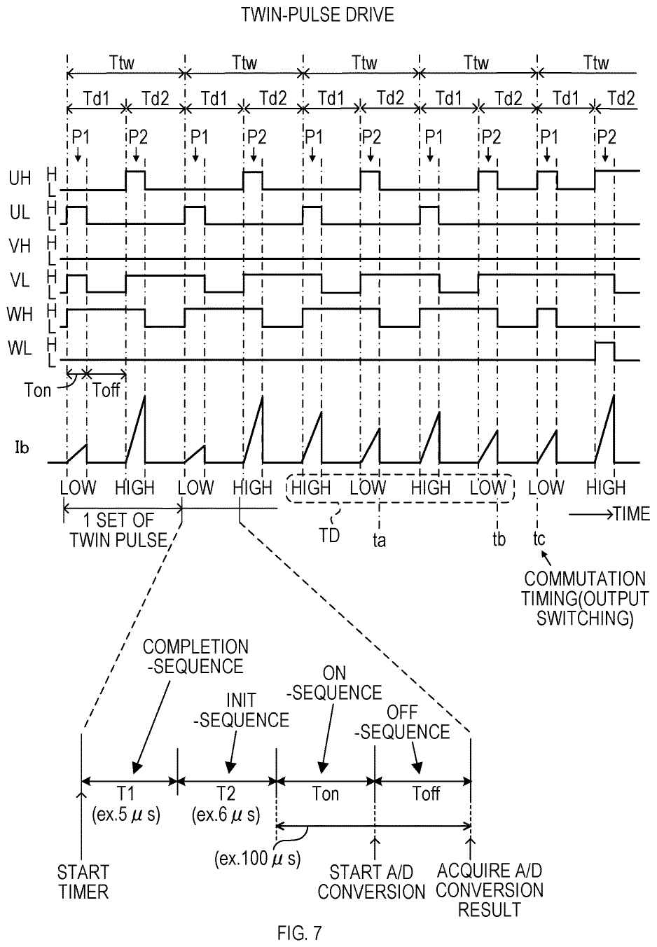

The control circuit 50 performs twin-pulse drive as exemplified in FIG. 7. That is, the control circuit 50 drives the inverter 42 in accordance with the switch pattern pair corresponding to the current rotational position and rotation direction. More specifically, the control circuit 50 alternately switches the energization pattern between the first pattern and the second pattern in the switch pattern pair in synchronization with a control cycle. The control cycle is a cycle in which PWM control of the motor 30 is performed.

In FIG. 7, P1 represents the first pattern, P2 represents the second pattern, Td1 represents a first drive period described later, Td2 represents a second drive period described later, and Ttw represents a twin-pulse drive period described later. The twin-pulse drive period is an example of the pair period in Overview of the Embodiments. FIG. 7 shows an example of twin-pulse drive when forward rotation and the rotational position of 180° are detected. Therefore, in FIG. 7, “UL, VL, WH” is set as the first pattern P1, and “UH, VL, WH” is set as the second pattern P2.

By performing driving in accordance with the switch pattern pair (specifically, driving in accordance with the first pattern P1 and the second pattern P2), power is supplied from the battery pack 20 to the motor 30 via the inverter 42. As a result, a current flows through the motor windings, and a rotational torque is generated in the motor 30.

Here, a power supply path when driving is performed in accordance with the first pattern P1 is referred to as a “first pattern path”, and a power supply path when driving is performed in accordance with the second pattern P2 is referred to as a “second pattern path”. Further, an inductance of the first pattern path is referred to as a “first inductance”, and an inductance of the second pattern path is referred to as a “second inductance”. Furthermore, a peak value (or a value proximate thereto) of the drive current Ib detected by the current detector 54 during driving with the first pattern P1 is referred to as a “first current value”, and a peak value (or a value proximate thereto) of the drive current Ib detected by the current detector 54 during driving with the second pattern P2 is referred to as a “second current value”.

Both the first and second pattern paths extend from the positive electrode of the battery pack 20 to the negative electrode of the battery pack 20 through the inverter 42 and the motor 30. That is, while the inverter 42 is being driven in accordance with the first pattern P1, power is supplied from the battery pack 20 to the motor 30 through the first pattern path. While the inverter 42 is being driven in accordance with the second pattern P2, power is supplied from the battery pack 20 to the motor 30 through the second pattern path. The first inductance may be an inductance of a portion of the first pattern path, particularly a portion of the motor 30 (specifically, the motor windings). Similarly, the second inductance may be an inductance of a portion of the second pattern path, particularly a portion of the motor 30 (specifically, the motor windings).

Both the first inductance and the second inductance change in accordance with the rotational position. For example, when the rotational position is within a first range, the first inductance is greater than the second inductance, and conversely, when the rotational position is within a second range, the first inductance is smaller than the second inductance. That is, the magnitude relationship between the inductances changes in accordance with the rotational position. The “magnitude relationship between the inductances” means a magnitude relationship between the first inductance and the second inductance in one switch pattern pair. In other words, the “magnitude relationship between the inductances” means which of the first inductance and the second inductance is greater (or smaller).

Therefore, every time the energization pattern is alternately switched to the first pattern P1 or the second pattern P2, a drive current value detected by the current detector 54 changes. In addition, a magnitude relationship between the current values changes in accordance with the rotational position of the motor 30. The “magnitude relationship between the current values” means a magnitude relationship between the first current value and the second current value in one switch pattern pair. In other words, the “magnitude relationship between the current values” means which of the first current value and the second current value is greater (or smaller).

Therefore, in the twin-pulse drive process, the rotational position of the motor 30 is detected (i.e., updated) based on the change in the magnitude relationship between the current values (in other words, based on the magnitude relationship between the inductances). Then, a commutation timing is identified every time the rotational position is updated. The commutation timing in the twin-pulse drive is a timing for switching the switch pattern pair.

Specifically, for each twin-pulse drive period, a first current value in a first drive period and a second current value in a second drive period are detected. Then, the rotational position of the motor 30 is detected at a timing when the magnitude relationship between the current values is reversed (in other words, a timing when the magnitude relationship between the inductances is reversed), and a commutation timing is identified based on the rotational position.

In FIG. 7, the magnitude relationship between the current values is reversed at a timing ta. That is, in FIG. 7, a state in which the second current value is greater than the first current value continues before the twin-pulse drive period that includes the timing ta. In contrast, in the twin-pulse drive period including the timing ta, the magnitude relationship between the current values is switched. That is, the first current value becomes greater than the second current value.

Therefore, the rotational position may be updated at this timing ta, and the start timing of the next control cycle may be determined as the commutation timing. Then, twin-pulse drive in accordance with a switch pattern pair corresponding to the updated rotational position may be performed from the determined commutation timing.

However, in the first embodiment, even after it is detected that the magnitude relationship between the current values is reversed at the timing ta, the twin-pulse drive in accordance with the same switch pattern pair is continued for at least one control cycle (one cycle in the first embodiment). Then, the rotational position is updated if the same magnitude relationship as that in the immediately preceding twin-pulse drive is maintained in the continued twin-pulse drive.

In the example of FIG. 7, switching of the magnitude relationship is detected at the timing ta. Then, the magnitude relationship is maintained at a timing tb after one control cycle has elapsed from the timing ta. That is, it is confirmed that the magnitude relationship between the current values does not change within an elapsed time TD during which multiple control cycles (two cycles in the first embodiment) elapse. Therefore, the control circuit 50 updates the rotational position at the timing tb and determines a timing tc, at which the next control cycle starts, as the commutation timing. Then, the control circuit 50 performs twin-pulse drive in accordance with the switch pattern pair corresponding to the updated rotational position from the timing tc.

In the technique described in Japanese Patent No. 7118699, the duty cycle in twin-pulse drive is fixed to a preset value. The duty cycle as used herein refers to a proportion of time during which a positive drive current Ib flows (more specifically, the time during which rotational torque in a prescribed direction is generated) within one control cycle. In other words, the duty cycle in twin-pulse drive means, with respect to the first drive period, a proportion of time during which driving is performed in accordance with the first pattern within one control cycle, and with respect to the second drive period, a proportion of time during which driving is performed in accordance with the second pattern within one control cycle. The drive current Ib in the forward direction is a drive current Ib that flows from the inverter 42 to the negative electrode of the battery pack 20 via the current detector 54. In other words, the drive current Ib in the forward direction is a drive current Ib for rotating the motor 30 in the prescribed direction. The prescribed direction is a set or designated rotational direction, which may be specified or may be settable by the user of the electric work machine 1. This duty cycle in the twin-pulse drive process is hereinafter referred to as “output duty”.

However, in the electric work machine 1 of the first embodiment, various work units with different functions can be selectively mounted to the work unit mounting portion 32. Therefore, a load applied from the work unit to the motor 30 (specifically, applied to the rotor) can vary significantly depending on the mounted work unit.

Therefore, if the output duty cycle is fixed, it may not be possible to generate appropriate rotational torque in the motor 30 depending on the load (in other words, the load torque) applied to the motor 30, potentially making it impossible to drive the motor 30. Alternatively, the rotational torque generated by the motor 30 may become excessively large, inhibiting a work tool from being driven properly.

Therefore, in the twin-pulse drive of the first embodiment, the output duty is controlled in accordance with the load such that the rotational speed can be properly increased to the termination rotational speed even if the load applied to the motor 30 changes. Basically, as the load applied to the motor 30 increases, the drive current value also increases. Therefore, it can be said that the drive current value indirectly indicates the magnitude of the load applied to the motor. Thus, in the present embodiment, the control of the output duty in accordance with the load is implemented by controlling the output duty in accordance with the drive current value.

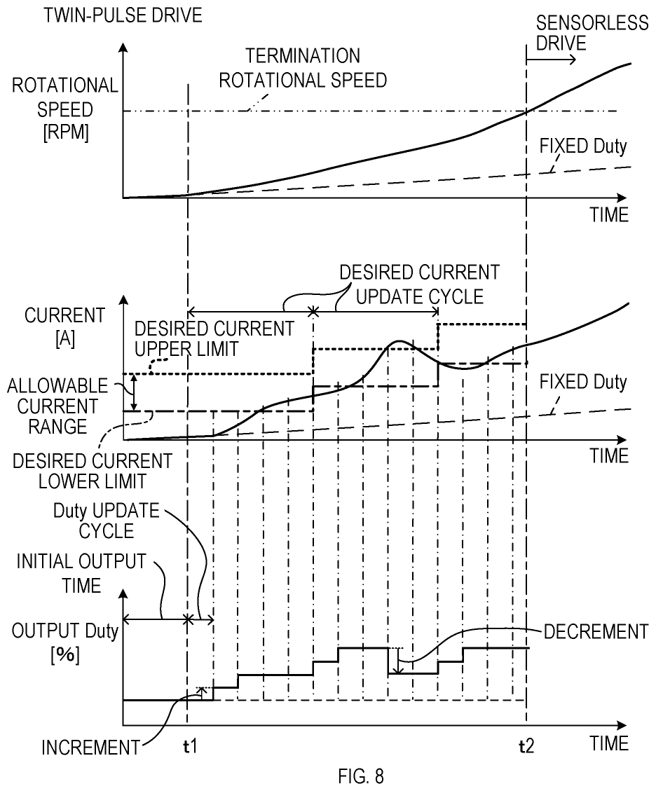

Specifically, as exemplified in FIG. 8, a current target (or a desired level) is set after the motor 30 starts driving. The current target is a target value or a target range of the magnitude of the current flowing through the motor 30 (specifically, for example, the drive current Ib; hereinafter referred to as “motor current”). The current target is set such that the rotational speed appropriately increases by the twin-pulse drive. The control circuit 50 controls the output duty such that the magnitude of the motor current matches the current target. Specifically, when the current target is a specific value (i.e., a desired current value), the control circuit 50 controls the output duty such that the magnitude of the motor current matches the desired current value. When the current target is a desired current range having a specific width, the control circuit 50 controls the output duty such that the magnitude of the motor current falls within the desired current range.

Specifically, the control circuit 50 sets a period in which driving is performed in accordance with one switch pattern pair (i.e., a period twice the control cycle) as a duty update cycle, and detects the magnitude of the motor current as the load of the motor 30 for each duty update cycle. The duty update cycle may be determined in any manner. In the first embodiment, the duty update cycle is a period in which driving is performed in accordance with one switch pattern pair (i.e., twice the control cycle) and is equal to the twin-pulse drive period.

The control circuit 50 increases the output duty by a specific increment when the detected magnitude of the motor current is lower than the current target, and decreases the output duty by a specific decrement when the magnitude of the motor current is higher than the current target. The decrement of the output duty is larger than the increment of the output duty. This is to better moderate an excessive increase in the rotational speed of the motor 30.

In the first embodiment, the desired current range is set as the current target. Specifically, a desired current upper limit and a desired current lower limit are set. The desired current upper limit is a maximum value of the desired current range, and the desired current lower limit is a minimum value of the desired current range. The desired current range may be referred to as a “permissible current range”.

For each duty update cycle, the control circuit 50 does not update the output duty if the detected magnitude of the motor current is between the desired current upper limit and the desired current lower limit (i.e., within the permissible current range). That is, the current output duty is maintained.

The current target is increased stepwise at every desired current update cycle after the motor 30 starts driving. The desired current update cycle is longer than the duty update cycle. By increasing the current target stepwise, large fluctuations in the motor current can be suppressed after the motor 30 starts driving. That is, the rotational speed of the motor 30 can be smoothly increased to the termination rotational speed (until time t2 in FIG. 8).

As shown in FIG. 8, the output duty is fixed to a minimum value from when the motor 30 starts driving by the twin-pulse drive until an initial output time elapses (until time t1 in FIG. 8). Then, from time t1 when the initial output time has elapsed, the control of the output duty is started. The initial output time and/or the minimum value may be set in advance or may be a constant value.

### [2-1-6. Flowcharts]

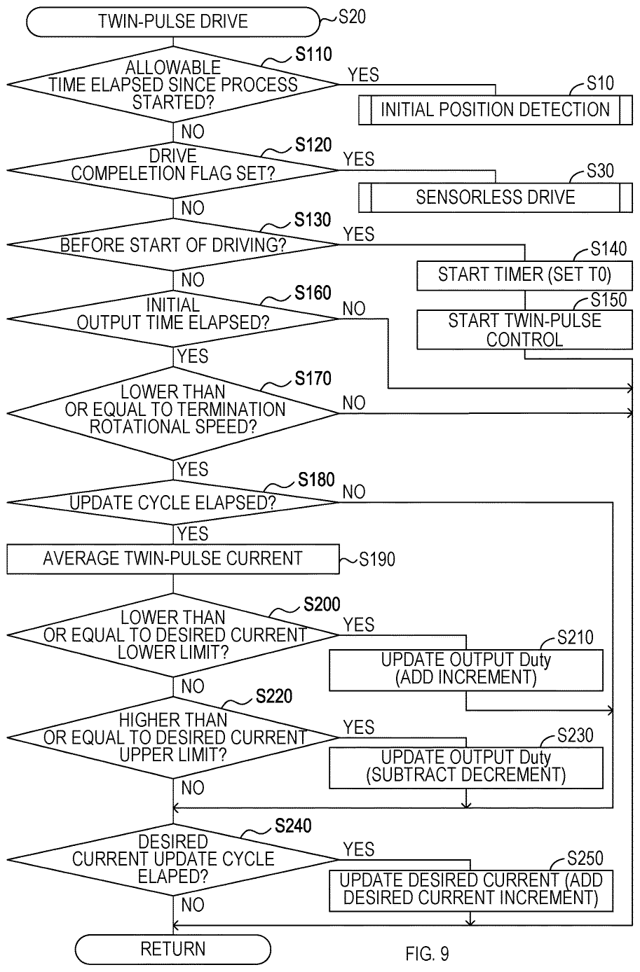

Next, a control process executed by the control circuit 50 to implement the twin-pulse drive as described above will be described with reference to the flowcharts shown in FIGS. 9 through 11.

In the first embodiment, it is necessary to set an on-time Ton and an off-time Toff in each control cycle (that is, in each first drive period or each second drive period) in accordance with the set output duty. The on-time Ton is a time during which driving is performed in accordance with the first pattern or the second pattern. The off-time Toff is a period for stopping the drive current Ib after the end of the on-time Ton.

Therefore, as shown in FIG. 7, driving during the on-time Ton is set as an ON-sequence, and driving during the off-time Toff is set as an OFF-sequence. Furthermore, a completion-sequence and an INIT-sequence are set. The completion-sequence is set to a fixed time T1 (for example, 5 μs) after the OFF-sequence, and the INIT-sequence is set to a fixed time T2 (for example, 6 μs) after the completion-sequence.

A time “Ton+Toff,” which is a sum of the time Ton of the ON-sequence and the time Toff of the OFF-sequence, is, for example, 100 μs. The time T1 of the completion-sequence and the time T2 of the INIT-sequence are sufficiently shorter than the time “Ton+Toff”. Therefore, the completion-sequence and the INIT-sequence have little or no effect on the twin-pulse drive.

In the first embodiment, a period during which one twin-pulse drive is performed is referred to as a “twin-pulse drive period”. A length of the twin-pulse drive period is twice the control cycle. The twin-pulse drive period includes the first drive period and the second drive period. A length of the first drive period and a length of the second drive period are equal to the control cycle.

The first drive period is a period during which a first pulse output based on the first pattern P1 is performed, and the second drive period is a period during which a second pulse output based on the second pattern P2 is performed. The “pulse output” means all the processing to be executed in each of the first drive period and the second drive period, that is, the entire output process of S310. As described above, in FIG. 7, the twin-pulse drive period is indicated by “Ttw”, the first drive period is indicated by “Td1”, and the second drive period is indicated by “Td2”. The first drive period corresponds to one control cycle period including a first energization period. The first energization period is a period during which driving is performed in accordance with the first pattern P1. The ON time Ton in the first drive period corresponds to a length of the first energization period. The second drive period corresponds to one control cycle period including second energization period. The second energization period is a period during which driving is performed in accordance with the second pattern P2. Each of the first drive period and the second drive period corresponds to a period from the start of the completion-sequence to the end of the OFF-sequence. In one twin-pulse drive period Ttw, the drive current Ib based on the first pattern P1 and the drive current Ib based on the second pattern P2 flow. Each of these drive currents Ib has a form similar to pulse. Therefore, driving the inverter 42 in accordance with the first and second patterns P1 and P2 (i.e., in accordance with the switch pattern pair) is referred to as twin-pulse drive.

Details of the twin-pulse drive process (S20) will be described with reference to FIG. 9. When the twin-pulse drive process is started, the control circuit 50 executes the processing of S110. In S110, the control circuit 50 determines whether a permissible time (for example, 500 ms) has elapsed since the twin-pulse drive process was started. The permissible time may be set in advance.

The determination in S110 that the permissible time has elapsed means that the rotational speed of the motor 30 has not yet reached the termination rotational speed even though the permissible time has passed since the start of the twin-pulse drive. Therefore, if the permissible time has elapsed, the control circuit 50 determines that the motor 30 has not been started normally, and the process returns to the initial position detection process in S10.

If it is determined in S110 that the permissible time has not elapsed, the process proceeds to S120. In S120, the control circuit 50 determines whether a drive completion flag is set.

The drive completion flag is set when the rotational speed of the motor 30 reaches (or exceeds) the termination rotational speed. In S120, the control circuit 50 determines whether an end condition for the twin-pulse drive process is satisfied by determining whether the drive completion flag is set. The drive completion flag being set means that the rotational speed is higher than or equal to the termination rotational speed. That is, the twin-pulse drive process should be ended and the process should transition to the sensorless drive process.

If it is determined in S120 that the drive completion flag is set, that is, it is determined that the end condition for the twin-pulse drive process is satisfied, the process transitions to the sensorless drive process in S30.

If it is determined in S120 that the drive completion flag is not set, the process proceeds to S130. In S130, the control circuit 50 determines whether the motor 30 has not yet started driving (specifically, the twin-pulse drive has not yet started). If the motor 30 has not yet started driving, the process proceeds to S140.

In S140, the control circuit 50 sets an initial time TO (for example, 5 μs) in the timer 53 and starts the timer 53. In S140, the control circuit 50 further sets a twin-pulse sequence (details of which will be described later) to the INIT-sequence. In S140, the control circuit 50 further sets an output count to an initial value (for example, “1”). The output count indicates which of the first drive period and the second drive period is the current period. The output count being set to the initial value indicates that the current period is the first drive period, and the output count being set to “initial value+1” indicates that the current period is the second drive period.

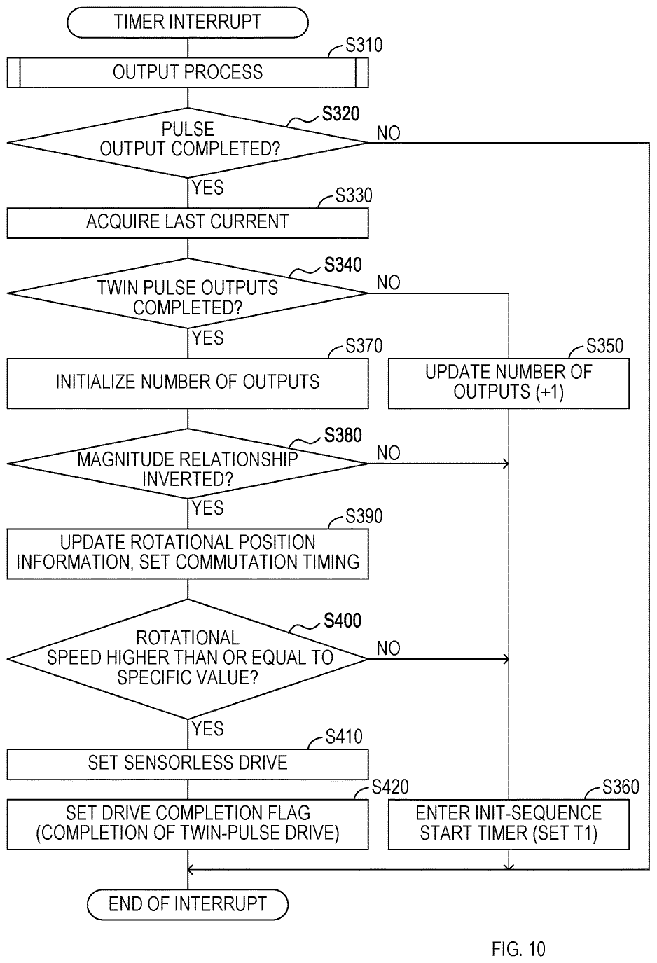

When the timer 53 is activated in S140, the timer 53 starts measuring time (i.e., counting). When the time measured by the timer 53 (i.e., a count variable) reaches an initial time T0, the control circuit 50 executes a timer interrupt process illustrated in FIG. 10. The initial time TO may be preset.

After the processing of S140, the process proceeds to S150. In S150, the control circuit 50 starts twin-pulse control and temporarily terminates the twin-pulse drive process. The control circuit 50 executes the twin-pulse drive process again when a prescribed time (e.g., 1 millisecond) has elapsed after temporarily terminating the twin-pulse drive process.

In the first embodiment, basically, when the twin-pulse drive process is started, it is determined in the first processing of S130 that driving has not yet started, and the process proceeds to S140. For the second and subsequent processing of S130, since the twin-pulse control has already been started in S150, it is determined that driving has started, and the process proceeds to S160.

If it is determined in S130 that the motor 30 has already started driving, the process proceeds to S160. In S160, the control circuit 50 determines whether the initial output time has elapsed after the start of driving the motor 30. If the initial output time has not elapsed, the control circuit 50 temporarily terminates the twin-pulse drive process. Until the initial output time elapses, the output duty is set to an initial value (i.e., the aforementioned minimum value). The initial value is preset for starting the motor 30.

If it is determined in S160 that the initial output time has elapsed, the process proceeds to S170. In S170, the control circuit 50 determines whether the rotational speed of the motor 30 is less than or equal to a termination rotational speed. If the rotational speed of the motor 30 exceeds the termination rotational speed, the control circuit 50 temporarily terminates the twin-pulse drive process.

If it is determined in S170 that the rotational speed of the motor 30 is less than or equal to the termination rotational speed, it is necessary to continue the twin-pulse drive of the motor 30. Therefore, in this case, the process proceeds to S180. In S180, the control circuit 50 determines whether the duty update cycle has elapsed since the last execution of the processing of S190 onward. If the duty update cycle has not elapsed, the control circuit 50 temporarily terminates the twin-pulse drive process.

If it is determined in S180 that the duty update cycle has elapsed, the process proceeds to S190. In S190, the control circuit 50 averages the current (twin-pulse current) that flowed through the motor 30 during the immediately preceding twin-pulse drive. The twin-pulse current includes the drive current Ib that flowed due to driving based on the first pattern P1 and the drive current Ib that flowed due to driving based on the second pattern P2.

The processing of S190 may be performed in any manner. In the first embodiment, in S190, an average value of the first current value and the second current value acquired in the timer interrupt process (see FIG. 10) during the immediately preceding twin-pulse drive is calculated. In other words, the processing of S190 is calculating the average value of the peak value (or a value proximate thereto) of the drive current Ib based on the first pattern P1 and the peak value (or a value proximate thereto) of the drive current Ib based on the second pattern P2.

In S200, the control circuit 50 determines whether the average value calculated in S190 is less than or equal to a desired current lower limit value. If the average value is less than or equal to the desired current lower limit value, the process proceeds to S210. In S210, the control circuit 50 updates the output duty.

In S210, the control circuit 50 adds a specific increment to the current output duty in order to increase the drive current Ib. After the output duty is updated in S210, the control circuit 50 temporarily terminates the twin-pulse drive process.

If it is determined in S200 that the average value is not less than or equal to the desired current lower limit value, the process proceeds to S220. In S220, the control circuit 50 determines whether the average value is greater than or equal to a desired current upper limit value.

If the average value is greater than or equal to the desired current upper limit value, the process proceeds to S230. In S230, the control circuit 50 updates the output duty and temporarily terminates the twin-pulse drive process. In S230, the control circuit 50 subtracts a specific decrement from the current output duty in order to suppress the increase in the drive current Ib.

If it is determined in S220 that the average value is not greater than or equal to the desired current upper limit value, the process proceeds to S240. In S240, the control circuit 50 determines whether the desired current update cycle has elapsed since the last execution of the processing of S250.

If it is determined in S240 that the desired current update cycle has elapsed, the process proceeds to S250. In S250, the control circuit 50 updates the desired current lower limit value and the desired current upper limit value (i.e., updates the permissible current range). Specifically, the control circuit 50 adds a desired current increment to the desired current lower limit value and desired current upper limit value. After the processing of S250, the control circuit 50 temporarily terminates the twin-pulse drive process. If it is determined in S240 that the desired current update cycle has not elapsed, the control circuit 50 temporarily terminates the twin-pulse drive process.

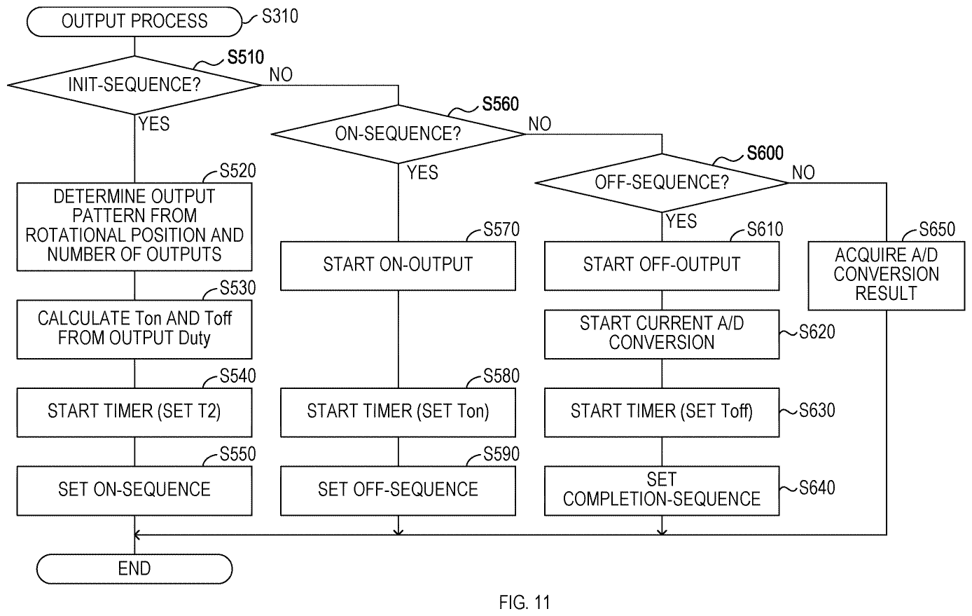

Next, the timer interrupt process shown in FIG. 10 will be described. When the timer interrupt process is started, the control circuit 50 executes the output process in S310. The output process includes outputting control signals that (i) follow each sequence of the twin-pulse drive illustrated in FIG. 7 (hereinafter referred to as a “twin-pulse sequence”) and (ii) correspond to the currently set output duty. Details of this output process will be described later based on FIG. 11.

After the output process is executed in S310, the process proceeds to S320. In S320, the control circuit 50 determines whether the pulse output in the current drive period (the first drive period or the second drive period) has been completed. Specifically, the control circuit 50 determines whether the process has advanced to a completion-sequence in the output process of S310 and whether the processing of S650 has also been completed.

If it is determined in S320 that the pulse output has not been completed, the control circuit 50 terminates the timer interrupt process. If it is determined in S320 that the pulse output has been completed, the process proceeds to S330. In S330, the control circuit 50 acquires the first current value or the second current value (i.e., A/D conversion value acquired in S650) in the current drive period and stores the acquired value in the memory 51. The digital value of the peak value (or a value proximate thereto) of each drive current Ib illustrated in FIG. 7 corresponds to the A/D conversion value. Specifically, the A/D conversion value of the drive current Ib based on the first pattern P1 corresponds to the aforementioned first current value, and the A/D conversion value of the drive current Ib based on the second pattern P2 corresponds to the aforementioned second current value.

When the first current value or the second current value is acquired and stored in S330, the process proceeds to S340. In S340, the control circuit 50 determines whether two pulse outputs by the twin-pulse drive have been completed. In other words, the control circuit 50 determines whether the pulse outputs in the first pattern P1 and the second pattern P2 shown in FIG. 7 have been completed. In still other words, the control circuit 50 determines whether one twin-pulse drive period has ended.

If it is determined in S340 that the two pulse outputs by the twin-pulse drive have not been completed, the process proceeds to S350. In S350, the control circuit 50 updates the output count by adding a value of 1 to the current output count.

After the processing of S350, the process proceeds to S360. In S360, the control circuit 50 sets the time T1 (e.g., 5 μs) in the timer 53 and activates the timer 53 such that the twin-pulse sequence enters the INIT-sequence at the next timer interrupt. After the timer 53 is activated in S360, the control circuit 50 terminates the timer interrupt process. That is, in S360, the twin-pulse sequence is set to the INIT-sequence.

If it is determined in S340 that the two pulse outputs by the twin-pulse control have been completed, the process proceeds to S370. In S370, the control circuit 50 initializes the output count. Specifically, for example, the control circuit 50 sets an initial value (e.g., “1”) for the output count.

By setting the output count in this manner, the control circuit 50 can determine an execution status of the twin-pulse drive based on the output count. Specifically, the control circuit 50 can determine whether the first pulse output in the twin-pulse drive has been completed (i.e., the first drive period has been completed) or the second pulse output has been completed (i.e., the second drive period has been completed).

In S380, the control circuit 50 determines whether the current magnitude relationship is inverted from the previous magnitude relationship. The “current magnitude relationship” refers to the magnitude relationship between the first current value and the second current value in the twin-pulse drive completed this time. The “previous magnitude relationship” refers to the magnitude relationship between the first current value and the second current value in the previous twin-pulse drive (the twin-pulse drive immediately preceding the one completed this time).

If it is determined in S380 that the current magnitude relationship is not inverted from the previous magnitude relationship, the process proceeds to S360. If it is determined in S380 that the current magnitude relationship is inverted from the previous magnitude relationship, the process proceeds to S390.

In S390, the control circuit 50 updates rotational position information of the motor 30. That is, the control circuit 50 determines that the motor 30 has further rotated by an electrical angle of 60 degrees from the rotational position currently detected (stored in the memory 51). Then, the control circuit 50 updates the current rotational position information stored in the memory 51. Although the detailed description is omitted in FIG. 10, more specifically in S390, at least one or more twin-pulse drives are performed even after the magnitude relationship between the currents is inverted, as described with reference to FIG. 7 (see TD in FIG. 7). Then, the rotational position information is updated based on the continued inverted state of the magnitude relationship.

In S390, the control circuit 50 further sets the commutation timing. In other words, the control circuit 50 establishes that a new commutation timing has arrived. More specifically, the control circuit 50 sets the switch pattern pair to be used to the switch pattern pair corresponding to the updated new rotational position information.

When the rotational position information is updated in S390, the process proceeds to S400. In S400, the control circuit 50 determines the current rotational speed of the motor 30 based on the elapsed time from the previous update of the rotational position information in S390 to the current update of the position information in S390. The control circuit 50 further determines whether the rotational speed is greater than or equal to a specific value. If it is determined that the rotational speed is not greater than or equal to the specific value, the process proceeds to S360 in order to continue the twin-pulse drive. In the first embodiment, the “specific value” is the aforementioned termination rotational speed.

If it is determined in S400 that the rotational speed is greater than or equal to the specific value, the process proceeds to S410. In S410, the control circuit 50 sets the drive of the motor 30 to sensorless drive. In S420, the control circuit 50 sets the drive completion flag. After the processing of S420, the control circuit 50 terminates the timer interrupt process. As a result, the drive of the motor 30 transitions from twin-pulse drive to sensorless drive.

Details of the output process in S310 will be described with reference to FIG. 11. The control circuit 50, when proceeding to the output process, determines in S510 whether the twin-pulse sequence is currently set to the INIT-sequence. If it is determined in S510 that the sequence is set to the INIT-sequence, the process proceeds to S520.

In S520, the control circuit 50 determines an output pattern based on information on a switch pattern pair (see Table 1) based on the current operating state. The “output pattern” refers to one of the first pattern P1 and the second pattern P2 that corresponds to the current operating state (in other words, corresponds to the current drive period). The “operating state” here includes the output count, the rotational position of the motor 30, and the rotational direction of the motor 30.

In the subsequent S530, the control circuit 50 calculates an ON time Ton and an OFF time Toff (see FIG. 7) for PWM control from the currently set output duty.

In S540, the control circuit 50 sets the time T2 (e.g., 6 μs) in the timer 53 and activates the timer 53 such that the twin-pulse sequence enters the ON-sequence at the next timer interrupt. In S550, the control circuit 50 sets the twin-pulse sequence to the ON-sequence and terminates the output process.

If it is determined in S510 that the twin-pulse sequence is not the INIT-sequence, the process proceeds to S560. In S560, the control circuit 50 determines whether the twin-pulse sequence is set to the ON-sequence.

If it is determined in S560 that the twin-pulse sequence is set to the ON-sequence, the process proceeds to S570. In S570, the control circuit 50 drives the inverter 42 in accordance with the output pattern set in S520, thereby supplying a drive current Ib in the forward direction to the motor 30. As a result, torque is generated in the motor 30, and the motor 30 rotates in the set direction.

In S580, the control circuit 50 sets the ON time Ton calculated in S530 in the timer 53 and activates the timer 53 such that the twin-pulse sequence enters the OFF-sequence at the next timer interrupt.

In S590, the control circuit 50 sets the twin-pulse sequence to the OFF-sequence and terminates the output process.

If it is determined in S560 that the twin-pulse sequence is not the ON-sequence, the process proceeds to S600. In S600, the control circuit 50 determines whether the twin-pulse sequence is set to the OFF-sequence.

If it is determined in S600 that the twin-pulse sequence is set to the OFF-sequence, the process proceeds to S610. In S610, the control circuit 50 initiates stopping of the supply of the drive current Ib to the motor 30 (more directly, to the inverter 42) in accordance with the output pattern set in S520. In S610, for example, the first through sixth switching elements Q1 through Q6 may be turned off.

In S620, the control circuit 50 causes the A/D converter 52 to start A/D conversion of the current detection signal input from the current detector 54. There is a slight time lag between the start of the process in S610 and the actual termination of the drive current Ib. Therefore, at the time S620 is started, the inverter 42 is still being driven in accordance with the output pattern of the ON-sequence. Consequently, in S620, the control circuit 50 can appropriately start the A/D conversion of the drive current Ib (more directly, the A/D conversion of the current detection signal) and, in turn, can appropriately acquire the first current value or the second current value. S620 may be executed before S610.

In S630, the control circuit 50 sets the OFF time Toff calculated in S530 in the timer 53 and activates the timer 53 such that the twin-pulse sequence enters the completion-sequence at the next timer interrupt. In S640, the control circuit 50 sets the twin-pulse sequence to the completion-sequence and terminates the output process.

If it is determined in S600 that the twin-pulse sequence is not the OFF-sequence, the twin-pulse sequence is the completion-sequence. Therefore, in this case, the process proceeds to S650.

In S650, the control circuit 50 acquires the A/D conversion result of the drive current Ib from the A/D converter 52. The A/D conversion result acquired here is the result of the A/D conversion started in S620. The control circuit 50 stores the acquired A/D conversion value in the memory 51 as the drive current value for the current drive period (i.e., the first current value or the second current value). The stored drive current value is used for determination of the magnitude relationship between the currents in S380.

### [2-1-7. Effects]

As described above, in the electric work machine 1 of the first embodiment, the motor 30 is driven by the twin-pulse drive during the period from when the motor 30 starts driving until the rotational speed reaches the termination rotational speed.

In the twin-pulse drive, the inverter 42 is driven in accordance with the switch pattern pair for each repeatedly arriving twin-pulse drive period. Specifically, the inverter 42 is driven in accordance with the first pattern P1 in the first drive period, and is subsequently driven in accordance with the second pattern P2 in the second drive period (see FIG. 7 and Table 1). Therefore, while the twin-pulse drive is being performed, the energization pattern is alternately switched between the first pattern P1 and the second pattern P2 for each control cycle.

Each time the twin-pulse drive period ends, the magnitude relationship between the current values is determined based on the first current value and the second current value acquired in that twin-pulse drive period. Then, at the timing when the magnitude relationship between the current values is inverted, the rotational position of the motor 30 is identified (i.e., updated), and the next commutation timing is set.

Therefore, in the twin-pulse drive, the rotational position can be detected and the commutation timing can be set without using the back EMF generated from the motor 30. This makes it possible to appropriately drive the motor 30 even when the back EMF cannot be detected (or when detection of the rotational position based on the back EMF is difficult or impossible), such as when the motor 30 is rotating at a low speed.

In the electric work machine 1 of the first embodiment, multiple types of work units can be selectively mounted. Therefore, the load applied to the motor 30 can vary significantly depending on the type of work unit.

In contrast, in the twin-pulse drive, the output duty for each of the first pattern P1 and the second pattern P2 is set in accordance with the current flowing through the motor 30 (specifically, the drive current value). That is, the output duty is set in accordance with the load applied to the motor 30. This inhibits the motor 30 from failing to be driven due to an increased load. Additionally, it is possible to inhibit unnecessary rotational torque from being generated in the motor 30 when the load is small, which would otherwise cause the work tool to be driven at a high speed.

In the first embodiment, the battery pack 20 corresponds to an example of the DC power source of the present disclosure. The timer interrupt process in FIG. 10 corresponds to an example of the “second through fourth operations” of the present disclosure. The processing of S180 through S250 in FIG. 9 corresponds to an example of the “fifth operation” of the present disclosure.

### 2-2. Second Embodiment

### [2-2-1. Features of Twin-Pulse Drive]

Another embodiment of the twin-pulse drive will be described as a second embodiment. The hardware configuration of the electric work machine of the second embodiment is basically the same as that of the electric work machine 1 of the first embodiment. The electric work machine of the second embodiment differs from the electric work machine 1 of the first embodiment in the twin-pulse drive of S20 (more specifically, the output process of S310).

In the first embodiment, a detailed description of the OFF-sequence was omitted. In the OFF-sequence, all switching elements Q1 through Q6 may be turned off, or a freewheeling path may be formed. The freewheeling path is (i) a loop-shaped energization path (i.e., a closed circuit) for allowing a freewheeling current to flow and (ii) is formed between the inverter 42 and the motor 30. The freewheeling current is generated by magnetic energy accumulated in the motor 30 (specifically, in the motor windings) during the ON-sequence. Therefore, the freewheeling current gradually decays. Unlike a so-called regenerative current, the freewheeling current does not flow into the battery pack 20.

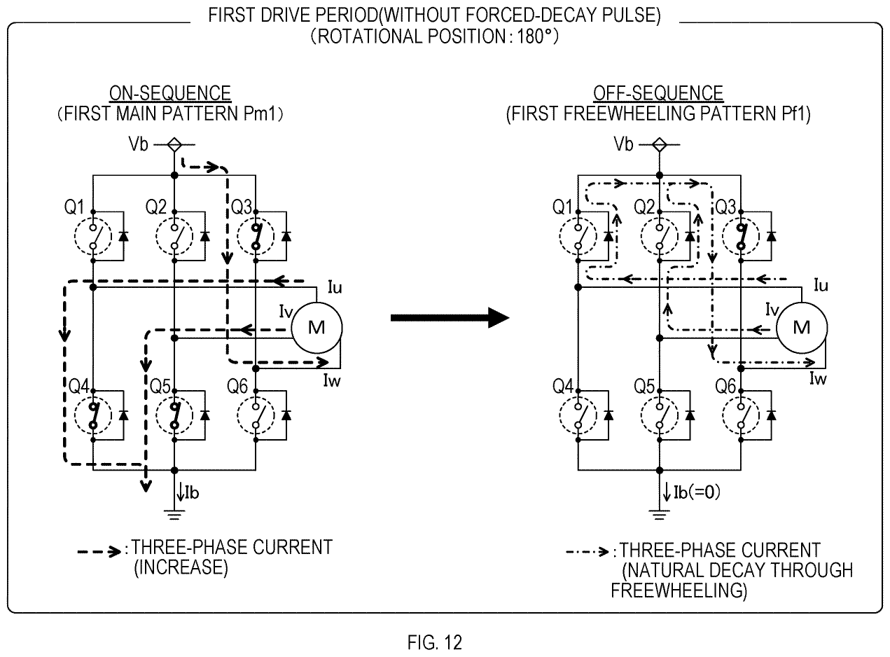

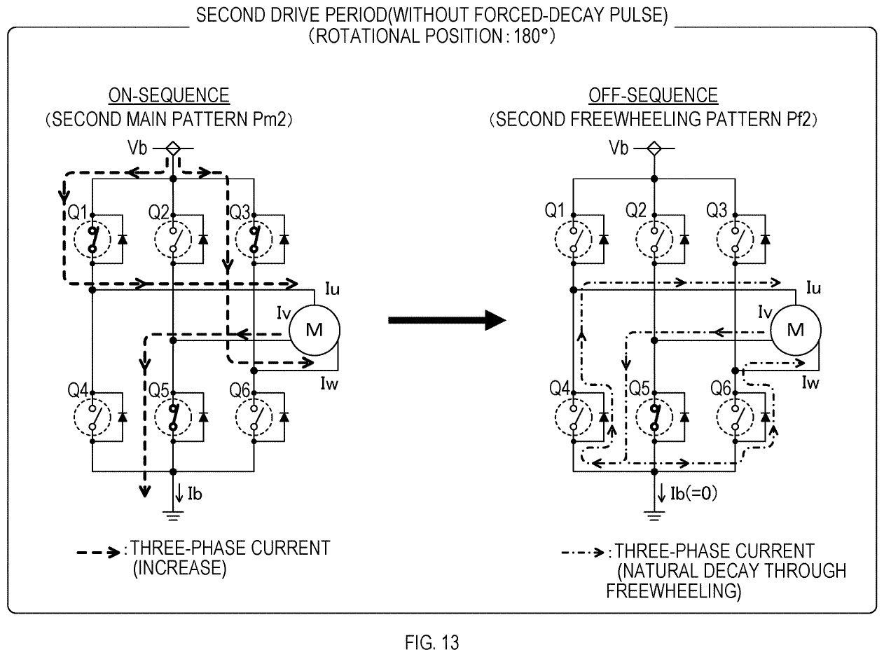

Before describing the twin-pulse drive of the second embodiment, the twin-pulse drive of a comparative example will be described with reference to FIGS. 12 and 13. FIG. 12 shows an example operation of the inverter 42 in the first drive period, and FIG. 13 shows an example operation of the inverter 42 in the second drive period. Both FIGS. 12 and 13 show example operations for a case where the detected rotational position is 180°.

The twin-pulse drive of the comparative example is the same as the twin-pulse drive of the first embodiment, except for the OFF-sequence. In the twin-pulse drive of the comparative example, a freewheeling path is formed in the OFF-sequence.

As shown in FIG. 12, in the first drive period of the comparative example, the inverter 42 is driven in accordance with a first main pattern Pm1 in the ON-sequence and is driven in accordance with a first freewheeling pattern Pf1 in the OFF-sequence.

As shown in FIG. 13, in the second drive period of the comparative example, the inverter 42 is driven in accordance with a second main pattern Pm2 in the ON-sequence and is driven in accordance with a second freewheeling pattern Pf2 in the OFF-sequence.

The first main pattern Pm1 corresponds to the aforementioned first pattern P1, and the second main pattern Pm2 corresponds to the aforementioned second pattern P2. That is, in the second embodiment, the “first pattern” is referred to as a “first main pattern” and the “second pattern” is referred to as a “second main pattern” for distinction from a forced-decay pattern described later.

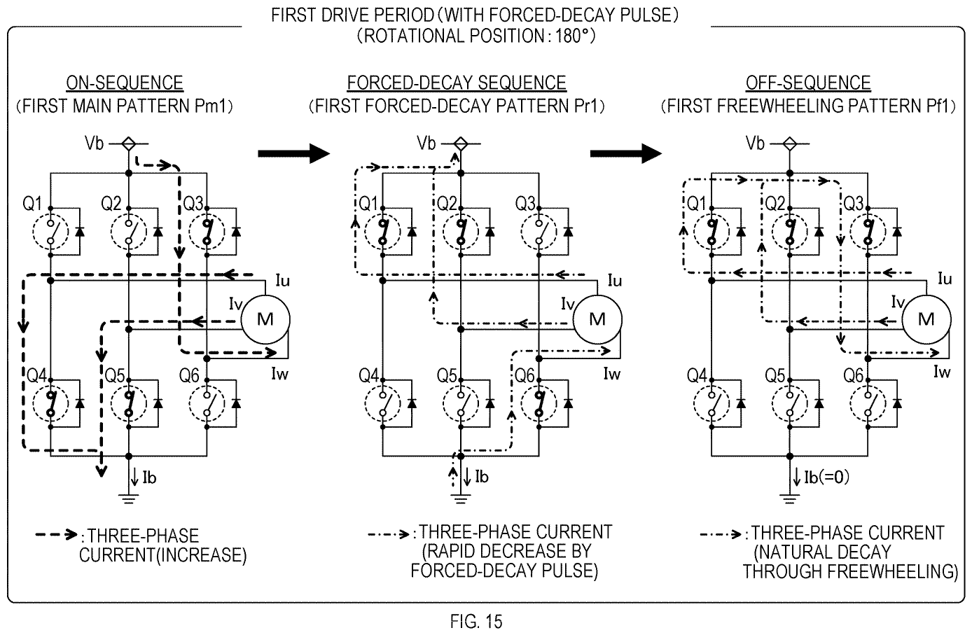

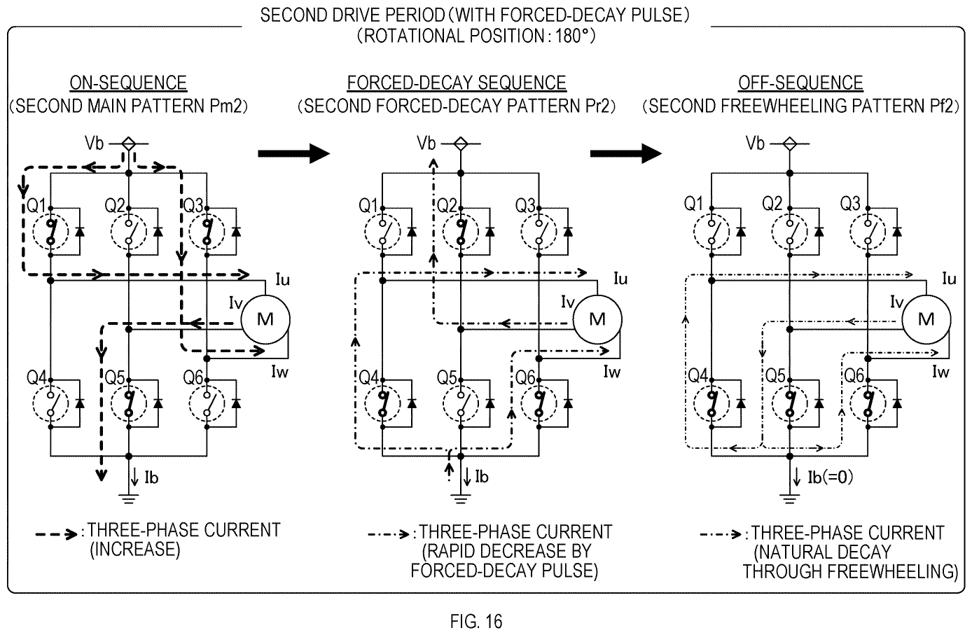

In the twin-pulse drive of the second embodiment, a forced-decay pulse is applied to the inverter 42 after the driving in accordance with the first main pattern Pm1 is completed and after the driving in accordance with the second main pattern Pm2 is completed. Specifically, as will be described later, after the driving in accordance with the first main pattern Pm1 is completed, the inverter 42 is driven a in accordance with a first forced-decay pattern Pr1 (see FIG. 15). After the driving in accordance with the second main pattern Pm2 is completed, the inverter 42 is driven in accordance with a second forced-decay pattern Pr2 (see FIG. 16).

That is, the forced-decay pulse means (i) three control signals set to H level by the first forced-decay pattern Pr1 in the first drive period, and (ii) three control signals set to H level by the second r forced-decay pattern Pr2 in the second drive period.

“Without forced-decay pulse” shown in FIGS. 12 and 13 means that application of the forced-decay pulse is not performed. “With forced-decay pulse” in FIGS. 15 and 16 means that the application of a forced-decay pulse is performed.

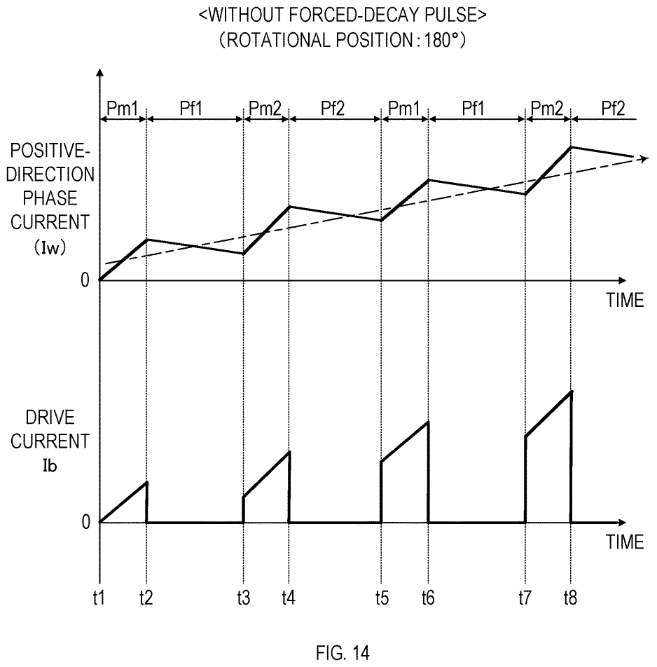

The description of the comparative example is continued with reference to FIGS. 12 and 13. In the first drive period, the three-phase currents Iu, Iv, and Iw and the drive current Ib flow through a path indicated by the dashed lines in FIG. 12 due to driving in accordance with the first main pattern Pm1. Consequently, as illustrated in FIG. 14, a positive-direction phase current and the drive current Ib gradually increase, and magnetic energy is accumulated in the motor 30 (specifically, in the motor windings). The magnetic energy accumulated in the motor windings by driving in accordance with the first main pattern Pm1 is an example of the first magnetic energy in Overview of Embodiments. The “positive-direction phase current” refers to a phase current among the three-phase currents that flows in a positive direction (i.e., flows into the motor 30) during both the first and second drive periods. At 180°, the positive-direction phase current in the first drive period is the W-phase current Iw.

In the first drive period, during the OFF-sequence, the inverter 42 is driven with the first freewheeling pattern Pf1 in order to reduce (and eventually zero out) the magnetic energy accumulated during the ON-sequence. In the first freewheeling pattern Pf1 at 180°, the control signal WH is set to H level and the other five control signals are set to L level, whereby only the third switching element Q3 is turned on. Therefore, in the OFF-sequence, a freewheeling current flows through a path indicated by a dot-dash line in FIG. 12 (an example of the first closed circuit in Overview of Embodiments). That is, the freewheeling current in this case flows through the first and second diodes D1 and D2 and the third switching element Q3. As a result, as illustrated in FIG. 14, the positive-direction phase current gradually decrease.

When the OFF-sequence of the first drive period ends, the process proceeds to the second drive period. In the second drive period, the process proceeds to the ON-sequence through very short completion and INIT-sequences.

The same applies to the second drive period. Magnetic energy is accumulated in the motor 30 (specifically, in the motor windings) by driving in accordance with the second main pattern Pm2 in the ON-sequence. The magnetic energy accumulated in the motor windings by driving in accordance with the second main pattern Pm2 is an example of the second magnetic energy in Overview of Embodiments. To discharge this magnetic energy, the inverter 42 is driven in accordance with the second freewheeling pattern Pf2 in the OFF-sequence. In the second freewheeling pattern Pf2 at 180°, the control signal VL is set to H level and the other five control signals are set to L level, whereby only the fifth switching element Q5 is turned on. Therefore, in the OFF-sequence, a freewheeling current flows through a path indicated by the dot-dash line in FIG. 13 (an example of the second closed circuit in Overview of Embodiments). That is, the freewheeling current in this case flows through the fourth and sixth diodes D4 and D6 and the fifth switching element Q5.

The first and second freewheeling patterns Pf1 and Pf2 may be determined in any manner as long as these patterns allow the freewheeling current to flow. For example, the first and second freewheeling patterns Pf1 and Pf2 may be set to turn on the first through third switching elements Q1 through Q3 while turning off the others, or conversely, to turn on the fourth through sixth switching elements Q4 through Q6 while turning off the others. The same applies to the twin-pulse drive when the rotational position is 60, 120, 240, 300, or 360 degrees.

If the duration of the OFF-sequence is too long, the rotational speed of the motor 30 may not increase (or may be difficult to increase), or the motor 30 may not rotate at all. Therefore, there is an upper limit to the duration of the OFF-sequence in order to allow the rotational speed of the motor 30 to reach the termination rotational speed.

Therefore, the OFF-sequence basically ends in a state where part of the magnetic energy accumulated in the motor 30 during the immediately preceding ON-sequence remains. That is, the next ON-sequence begins while part of the magnetic energy accumulated in the preceding ON-sequence is still present.

Specifically, as illustrated in FIG. 14, when driving in accordance with the first main pattern Pm1 starts at time t1, the positive-direction phase current gradually increases from zero. When the drive pattern switches to the first freewheeling pattern Pf1 at time t2, the positive-direction phase current gradually decreases. However, at time t3, before the positive-direction phase current reaches zero (i.e., while part of the magnetic energy accumulated between t1 and t2 remains), the twin-pulse sequence transitions to the ON-sequence of the second drive period.

In the ON-sequence of the second drive period, the inverter 42 is driven in accordance with the second main pattern Pm2, causing the positive-direction phase current to increase again. When the drive pattern switches to the second freewheeling pattern Pf2 at time t4, the positive-direction phase current gradually decreases. However, while part of the magnetic energy accumulated in the preceding ON-sequence (t3 through t4) remains, the twin-pulse sequence transitions to the ON-sequence of the next first drive period at time t5. t1 through t3 is the first drive period, and t3 through t5 is the second drive period. t1 through t5 constitutes one twin-pulse drive period, and this twin-pulse drive period is repeated after t5.

As described above, in the OFF-sequence, the magnetic energy of the motor 30 is reduced by the freewheeling current. However, the magnetic energy accumulated in the preceding ON-sequence is not completely discharged (or is difficult to discharge completely). Therefore, as illustrated in FIG. 14, the positive-direction phase current, as a whole, increases over time. Consequently, as illustrated in FIG. 14, the drive current Ib observed during each ON-sequence also increases over time. A dot-dash arrow in FIG. 14 schematically shows the upward trend of the positive-direction phase current (and the upward trend of the drive current Ib).

Such a rise in the drive current Ib may cause excessive torque during the startup of the motor 30. Therefore, it is desirable for the upward trend of the drive current Ib to be as small as possible (ideally zero).

By lowering the output duty, the upward trend can be reduced to some extent. However, if the output duty is too low, the difference between the first current value and the second current value becomes small, making it difficult or impossible to determine the magnitude relationship between the two. To detect the rotational position based on the magnitude relationship, it is required that the difference between the first and second current values be at or above a certain level. Thus, there is also a lower limit for the output duty. Therefore, it is not easy to sufficiently reduce the upward trend of the drive current Ib merely by lowering the output duty.

Accordingly, the twin-pulse drive of the second embodiment includes a forced-decay sequence to inhibit the upward trend of the drive current Ib caused by magnetic energy. In the forced-decay sequence, the aforementioned forced-decay pulse is applied to the inverter 42.

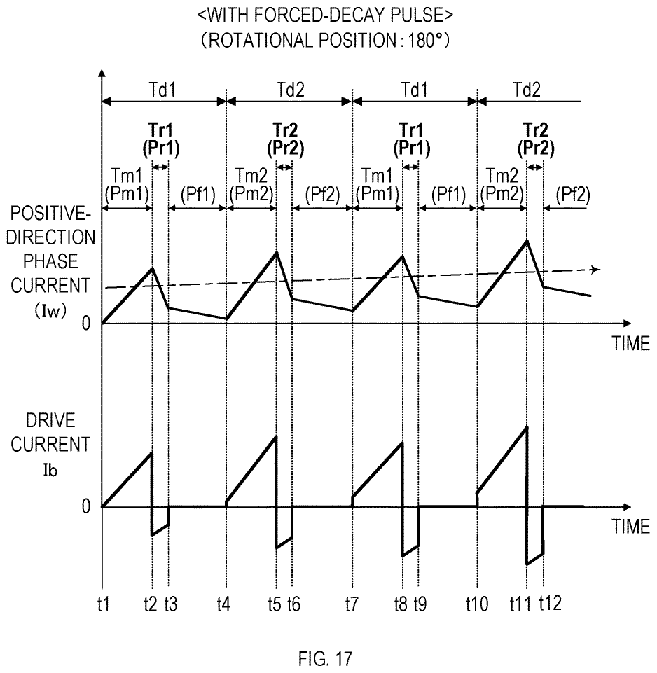

In other words, in the second embodiment, the first drive period includes a first forced-decay period after the first energization period, and the second drive period includes a second forced-decay period after the second energization period. The first forced-decay period is a period in which a forced-decay sequence is set, specifically, a period during which the inverter 42 is driven in accordance with a first forced-decay sequence Pr1 described later. Similarly, the second forced-decay period is a period in which a forced-decay sequence is set, specifically, a period during which the inverter 42 is driven in accordance with a second forced-decay sequence Pr2 described later. In FIG. 17, “Tm1” represents the first energization period, “Tr1” represents the first forced-decay period, “Tm2” represents the second energization period, and “Tr2” represents the second forced-decay period.

The first drive period includes a first freewheeling period after the first forced-decay period. The first freewheeling period is a period during which the inverter 42 is driven in accordance with the first freewheeling pattern Pf1. The second drive period includes a second freewheeling period after the second forced-decay period. The second freewheeling period is a period during which the inverter unit 42 is driven in accordance with the second freewheeling pattern Pf2.

The forced-decay sequence may be provided in at least one of the first drive period and the second drive period. In the first embodiment, the forced-decay sequence is provided in both the first and second drive periods. Specifically, as shown in FIGS. 15 and 16, the forced-decay sequence is provided between the ON-sequence and the OFF-sequence in each of the first and second drive periods. That is, after the ON-sequence, the process proceeds to the OFF-sequence via the forced-decay sequence.

In the OFF-sequence, since a freewheeling path is formed between the inverter 42 and the motor 30 without passing through the battery pack 20, the drive current Ib basically does not flow.

In contrast, in the forced-decay sequence, (i) the battery voltage is applied to the motor 30, and (ii) an energization path is formed from the battery pack 20 to the motor 30 via the inverter 42. That is, the drive current Ib flows during the forced-decay sequence.

The forced-decay sequence is provided to quickly reduce the magnetic energy accumulated in the motor 30 during the preceding ON-sequence (faster than in the OFF-sequence). To achieve this, in the forced-decay sequence, a regenerative current flows between the battery pack 20 and the motor 30 via the inverter 42. In other words, in the forced-decay sequence, the drive current Ib flows in the negative direction. By generating a regenerative current to forcibly (or actively) discharge the magnetic energy of the motor 30, the magnetic energy of the motor 30 can be reduced more rapidly. Through such a forced-decay sequence, at least a portion (in this second embodiment, more than half or all) of the magnetic energy accumulated in the motor 30 during the immediately preceding ON-sequence is discharged externally from the motor 30.

Specifically, in the forced-decay sequence, a forced-decay pulse is applied such that at least one of the first through third terminals 30U, 30V, and 30W of the motor 30 is electrically coupled to a current suppression electrode of the battery pack 20. The “current suppression electrode” is the one of the positive and negative electrodes whose polarity differs from the electrode electrically coupled via the inverter 42 during the ON-sequence. For example, the current suppression electrode of a terminal coupled to the positive electrode of the battery pack 20 via the inverter 42 during the ON-sequence is the negative electrode. The current suppression electrode of a terminal coupled to the negative electrode of the battery pack 20 during the ON-sequence is the positive electrode.

In the forced-decay sequence, the inverter 42 may be driven in accordance with any switch pattern as long as the purpose of the forced-decay sequence (reducing magnetic energy more quickly than the freewheeling pattern) can be achieved.

In other words, the switch pattern in the forced-decay sequence (i.e., the forced-decay pulse) may be determined in any manner as long as (i) a regenerative current (i.e., negative drive current Ib) can be made to flow to the battery pack 20, and/or (ii) at least one of the first through third terminals 30U, 30V, and 30W is electrically coupled to the current suppression electrode via the inverter 42.

In the forced-decay sequence of the second embodiment, the inverter 42 is driven in a manner that is completely opposite to the immediately preceding ON-sequence. That is, the switching elements that were turned off during the ON-sequence are turned on, and the switching elements that were turned on during the ON-sequence are turned off. In other words, the inverter 42 is driven such that each of the first through third terminals 30U, 30V, and 30W is coupled to its corresponding current suppression electrode. Therefore, the forced-decay sequence may be referred to as a reverse-phase sequence, the forced-decay pattern may be referred to as a reverse-phase pattern, and the forced-decay pulse may be referred to as a reverse-phase pulse.

The twin-pulse drive of the second embodiment will be specifically described with reference to FIGS. 15 and 16. FIG. 15 shows an example operation of the inverter 42 in the first drive period, and FIG. 16 shows an example operation of the inverter 42 in the second drive period. Similar to FIGS. 12 and 13, both FIGS. 15 and 16 show example operations for a case where the detected rotational position is 180°.

The example operation of the first drive period shown in FIG. 15 differs from that of FIG. 12 in that a forced-decay pattern is added between the ON-sequence and the OFF-sequence, but is otherwise the same as that of FIG. 12. That is, in the first drive period, after the ON-sequence ends (i.e., after the driving in accordance with the first main pattern Pm1 is completed), the twin-pulse sequence transitions to the forced-decay sequence. In the forced-decay sequence, the inverter 42 is driven in accordance with the first forced-decay pattern Pr1.

The first forced-decay pattern Pr1 is “UH, VH, WL,” which is the direct opposite of the immediately preceding ON-sequence. Therefore, as shown in FIG. 15, the first, second, and sixth switching elements Q1, Q2, and Q6 are turned on, and the other three are turned off. As a result, while the first and second terminals 30U and 30V were coupled to the negative electrode of the battery pack 20 during the ON-sequence, the first and second terminals 30U and 30V are coupled to the positive electrode during the forced-decay sequence. Similarly, while the third terminal 30W was coupled to the positive electrode of the battery pack 20 during the ON-sequence, the third terminal 30W is coupled to the negative electrode during the forced-decay sequence.

If the inverter 42 were driven with the first forced-decay pattern Pr1 in a state where no current was flowing through the motor 30, the U-phase and V-phase currents Iu, Iv and the drive current Ib would flow in the positive direction, while the W-phase current Iw would flow in the negative direction. However, in the second embodiment, the twin-pulse sequence transitions to the forced-decay sequence while the magnetic energy accumulated in the motor 30 during the ON-sequence remains.

Therefore, as indicated by the dot-dash lines in FIG. 15 and as shown between t2 through t3 and t8 through t9 for the positive-direction phase current in FIG. 17, the directions of the three-phase currents Iu, Iv, and Iw remain unchanged for a while (i.e., as long as the magnetic energy does not reach zero) even after the twin-pulse sequence transitions to the forced-decay sequence.

However, since the switch pattern is the direct opposite of that in the ON-sequence, the drive current Ib flows in the direction opposite to the positive direction. That is, the drive current Ib flows from the negative electrode of the battery pack 20, through the inverter 42 and the motor 30, toward the positive electrode of the battery pack. FIG. 17 shows that the negative drive current Ib flows during the forced-decay sequence of the first drive period (t2 through t3, t8 through t9).

Due to this first forced-decay pattern Pr1, the magnetic energy of the motor 30 decays more rapidly than it would through decay caused by a freewheeling current. Specifically, as shown between t2 through t3 and t8 through t9 in FIG. 17, the positive-direction phase current decreases rapidly, and the negative drive current Ib also approaches zero.

Then, once a large portion of the magnetic energy has been discharged by the forced-decay sequence, the twin-pulse sequence transitions to the OFF-sequence. In the OFF-sequence, the magnetic energy gradually decreases due to the freewheeling current. However, because of the immediately preceding forced-decay sequence, the magnetic energy at the start of the OFF-sequence has already decayed to a low level. Therefore, by the end of the OFF-sequence, most (or all) of the magnetic energy accumulated in the preceding ON-sequence has been discharged.

The same applies to the second drive period. That is, the example operation of the second drive period shown in FIG. 16 differs from that of FIG. 13 in that a forced-decay pattern is added between the ON-sequence and the OFF-sequence, but is otherwise the same as that of FIG. 13. Specifically, in the second drive period, after the ON-sequence ends (i.e., after the driving in accordance with the second main pattern Pm2 is completed), the twin-pulse sequence transitions to the forced-decay sequence. In that forced-decay sequence, the inverter 42 is driven in accordance with the second forced-decay pattern Pr2.

The second forced-decay pattern Pr2 is “VH, UL, WL”, which is the direct opposite of the immediately preceding ON-sequence. Therefore, as shown in FIG. 16, the second, fourth, and sixth switching elements Q2, Q4, Q6 are turned on, and the other three are turned off. Energy has been accumulated in the motor 30 by the immediately preceding ON-sequence. Accordingly, as indicated by the dot-dash lines in FIG. 16 and as shown between t5 through t6 and t11 through t12 for the positive-direction phase current in FIG. 17, the directions of the three-phase currents Iu, Iv, and Iw remain unchanged for a while (i.e., as long as the magnetic energy does not reach zero) even after the twin-pulse sequence transitions to the forced-decay sequence.

However, since the switch pattern is the direct opposite of that in the ON-sequence, the drive current Ib flows in the direction opposite to the positive direction, similar to the forced-decay sequence of the first drive period. FIG. 17 shows that the negative drive current Ib flows during the forced-decay sequence of the second drive period (t5 through t6, t11 through t12).

Due to this second forced-decay pattern Pr2, the magnetic energy of the motor 30 decays more rapidly than it would through decay caused by the freewheeling current. Specifically, as shown between t5 through t6 and t11 through t12 in FIG. 17, the positive-direction phase current decreases rapidly, and the negative drive current Ib also approaches zero.

Then, similar to the first drive period, once a large portion of the magnetic energy accumulated during the ON-sequence has been discharged by the forced-decay sequence, the twin-pulse sequence transitions to the OFF-sequence. After the second drive period ends, the next twin-pulse drive is started.

As described above, the ON-sequence, the forced-decay sequence, and the OFF-sequence are set in each of the first and second drive periods.

One of the most significant features of the second embodiment is the provision of the forced-decay sequence. The provision of the forced-decay sequence itself can achieve part or all of the intended objectives. The intended objective is to inhibit accumulation (rise) of the magnetic energy of the motor 30 caused by repeated twin-pulse drives, in other words, to suppress generation of excessive output torque in the motor 30.

Therefore, main pattern time, forced-decay pattern time, the freewheeling pattern time may be determined in any manner.

The “main pattern time” is a duration for which driving in accordance with a main pattern is continued in each of the first and second drive periods. The main pattern time corresponds to the aforementioned ON time Ton. The main pattern time in the first drive period is an example of the “length of the first energization period” in Overview of Embodiments, and the main pattern time in the second drive period is an example of the “length of the second energization period” in Overview of Embodiments.

The “forced-decay pattern time” is a duration for which driving in accordance with a forced-decay pattern is continued in each of the first and second drive periods. The forced-decay pattern time in the first drive period is an example of the “length of the first forced-decay period” in Overview of Embodiments, and the forced-decay pattern time in the second drive period is an example of the “length of the second forced-decay period” in Overview of Embodiments.

The “freewheeling pattern time” is a duration for which driving in accordance with a freewheeling pattern is continued in each of the first and second drive periods. Since the third dead time immediately preceding the driving in accordance with the freewheeling pattern is negligible, the freewheeling pattern time may be a duration of the OFF-sequence.

Merely as an example, in the second embodiment, the main pattern time, the forced-decay pattern time, and the freewheeling pattern time are set such that a first setting requirement and/or a second setting requirement is/are satisfied.

The first setting requirement is satisfied by the average value of the drive current Ib during the twin-pulse drive period being less than 30% of a drive current peak value during the twin-pulse drive period. The drive current peak value is a peak value (maximum value) of the drive current Ib.

The second setting requirement is satisfied by the average value of the positive-direction phase current during the twin-pulse drive period being less than 80% of a phase current peak value during the twin-pulse drive period. The phase current peak value is a peak value (maximum value) of the positive-direction phase current.

By setting the main pattern time, the forced-decay pattern time, and the freewheeling pattern time to satisfy the first setting requirement and/or the second setting requirement, the intended objective can be achieved more effectively.

To satisfy the first setting requirement and/or the second setting requirement, for example, the main pattern time may be set within a range of 25% through 55% of the control cycle, the forced-decay pattern time may be set within a range of 5% through 30% of the control cycle, and the freewheeling pattern time may be set within a range of 30% through 60% of the control cycle.

Merely as an example, the main pattern time may be around 40% of the control cycle, the forced-decay pattern time may be around 15% of the control cycle, and the freewheeling pattern time may be around 45% of the control cycle.

The main pattern time and the forced-decay pattern time may be determined preferentially such that the magnetic energy can be sufficiently reduced by the forced-decay sequence (i.e., to achieve the intended objective) without relying on the reduction of magnetic energy in the OFF-sequence. In this case, for example, the main pattern time may be 25% through 65% of the control cycle, and the forced-decay pattern time may be 5% through 40% of the control cycle. Specifically, the main pattern time may be around 40% of the control cycle, and the forced-decay pattern time may be around 20% of the control cycle.

Constant values may be preset (e.g., stored in the memory 51) for the main pattern time, the forced-decay pattern time, and/or the freewheeling pattern time, respectively. The same applies to first through third dead times described later.

However, in the second embodiment, the main pattern time is calculated based on the currently set output duty, similar to the ON time Ton in the first embodiment. The output duty in the second embodiment is a proportion of the main pattern time within one control cycle, similar to the first embodiment. In the second embodiment as well, the output duty is set in accordance with the load externally applied to the motor 30, in the same manner as in the first embodiment. That is, the output duty is set such that the drive current value reaches a desired level.

Then, the forced-decay pattern time is calculated based on the calculated main pattern time. The forced-decay pattern time may be calculated in any manner. In the second embodiment, the forced-decay pattern time is calculated such that the forced-decay pattern time becomes longer as the main pattern time becomes longer. The freewheeling pattern time may be calculated, for example, by subtracting the main pattern time and the forced-decay pattern time from the control cycle.

In the second embodiment, within one twin-pulse drive period, the main pattern time, the forced-decay pattern time, and the freewheeling pattern time in the second drive period are respectively equal to the main pattern time, the forced-decay pattern time, and the freewheeling pattern time in the first drive period.

However, the main pattern time in the second drive period may differ from the main pattern time in the first drive period. Similarly, the forced-decay pattern time in the second drive period may differ from the forced-decay pattern time in the first drive period, and the freewheeling pattern time in the second drive period may differ from the freewheeling pattern time in the first drive period. The same applies to the first through third dead times.

As described above, in the second embodiment, the magnetic energy of the motor 30 is rapidly reduced by the forced-decay sequence after the ON-sequence. Therefore, as is clear from a comparison between FIG. 14 and FIG. 17, the upward trend of the positive-direction phase current and the upward trend of the drive current Ib are kept sufficiently lower than those in the comparative example. This moderates an excessive increase in the torque of the motor 30.

Although descriptions are omitted in FIGS. 12 through 17, a very short dead time is provided as required to avoid or inhibit an arm short-circuit in the twin-pulse drive. The “arm short-circuit” refers to a condition in which both of the two switching elements in the same arm (or the same leg) of the inverter 42 are turned on simultaneously.

Specifically, in the ON-sequence, the first dead time is provided immediately before driving in accordance with the main pattern. In the forced-decay sequence, the second dead time is provided immediately before driving in accordance with the forced-decay pattern. In the OFF-sequence, the third dead time is provided immediately before driving in accordance with the freewheeling pattern. A first dead-time process is executed during the first dead time, a second dead-time process is executed during the second dead time, and a third dead-time process is executed during the third dead time.

Each dead-time process for the case where the rotational position is 180° will be specifically described. In the first dead-time process in the first drive period, the sixth switching element Q6, which was turned on during the OFF-sequence of the immediately preceding second drive period, is turned off. As a result, only the fourth and fifth switching elements Q4 and Q5 are placed in an ON state.

In the second dead-time process in the first drive period, all of the first through sixth switching elements Q1 through Q6 are turned off.

In the third dead-time process in the first drive period, the sixth switching element Q6, which was turned on during the immediately preceding forced-decay sequence, is turned off. As a result, only the first and second switching elements Q1 and Q2 are placed in an ON state.

In the first dead-time process in the second drive period, the second switching element Q2, which was turned on during the OFF-sequence of the immediately preceding first drive period, is turned off. As a result, only the first and third switching elements Q1 and Q3 are placed in an ON state.

In the second dead-time process in the second drive period, all of the first through sixth switching elements Q1 through Q6 are turned off.

In the third dead-time process in the second drive period, the second switching element Q2, which was turned on during the immediately preceding forced-decay sequence, is turned off. As a result, only the fourth and sixth switching elements Q4 and Q6 are placed in an ON state.

The length of each dead time is significantly shorter than lengths of the ON-sequence, the forced-decay sequence, and the OFF-sequence. Therefore, each dead time has almost no influence on driving of the motor 30.

The above-described driving of the inverter 42 in each dead-time process is merely an example. In each dead-time process, the inverter 42 may be driven in any manner as long as the objective of the dead-time process (avoidance of arm short-circuits) can be fulfilled. The same applies to the twin-pulse drive when the rotational position is 60, 120, 240, 300, or 360 degrees.

### [2-2-2. Output Process]

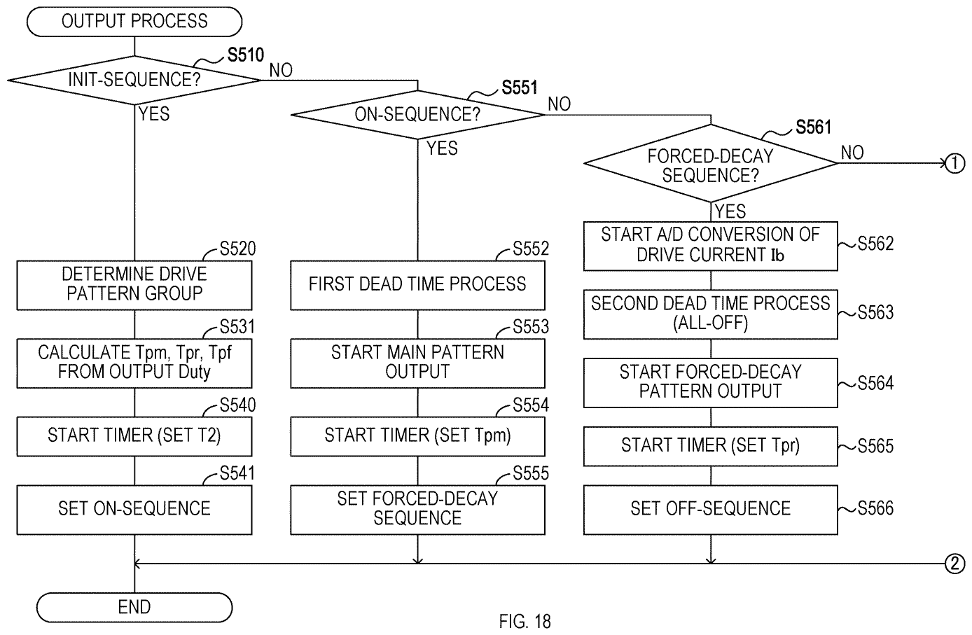

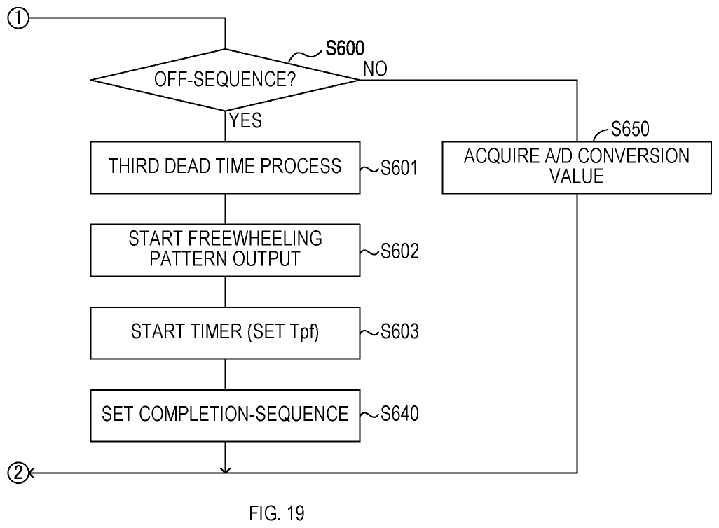

In the second embodiment, as in the first embodiment, the drive control process (FIG. 4) and the timer interrupt process (FIG. 10) are executed. However, the output process of S310 in the timer interrupt process differs from that of the first embodiment. Specifically, while the output process in the first embodiment is as shown in FIG. 11, the output process in the second embodiment is as shown in FIGS. 18 and 19. Therefore, the output process in the second embodiment will be described with reference to FIGS. 18 and 19. In FIGS. 18 and 19, processes identical to those in FIG. 11 are denoted by the same reference numerals as in FIG. 11.

The control circuit 50, when starting the output process, determines in S510 whether the twin-pulse sequence is set to the INIT-sequence. If the twin-pulse sequence is set to the INIT-sequence, the process proceeds to S520.

In S520, the control circuit 50 determines a drive pattern group to be used in the current drive period based on the currently detected rotational position, the currently set output count, the rotational direction of the motor 30, and the switch pattern table shown in Table 1. The drive pattern group includes the main pattern, the forced-decay pattern, and the freewheeling pattern. The drive pattern group may also include drive patterns for the first through third dead-time processes. In the second embodiment, the “first pattern” in Table 1 is read as a “first main pattern Pm1”, and the “second pattern” is read as a “second main pattern Pm2”.

For example, assume a case where the current rotational position is 180°, the output count is “initial value+1” and the rotational direction is the forward direction. In this case, since the current period is the second drive period, the second main pattern Pm2, the second forced-decay pattern Pr2, and the second freewheeling pattern Pf2 illustrated in FIG. 16 are determined in S520. Furthermore, the first through third dead-time processes are determined.

As another example, assume a case where the current rotational position is 180°, the output count is the “initial value” and the rotational direction is the forward direction. In this case, since the current period is the first drive period, the first main pattern Pm1, the first forced-decay pattern Pr1, and the first freewheeling pattern Pf1 illustrated in FIG. 15 are determined in S520. Furthermore, the drive patterns for the first through third dead-time processes are determined.

The first forced-decay pattern Pr1, the second forced-decay pattern Pr2, the first freewheeling pattern Pf1, and the second freewheeling pattern Pf2 may be preset in the switch pattern table of Table 1 for each rotational position and each rotational direction. In this case, the drive pattern group may be determined based on that switch pattern table.

Alternatively, since the forced-decay pattern is the direct opposite of the main pattern, the forced-decay pattern may be determined based on the main pattern once the main pattern has been determined based on Table 1.

The first freewheeling pattern Pf1 may be a constant pattern regardless of the rotational position and the rotational direction (e.g., the pattern illustrated in FIG. 15). Similarly, the second freewheeling pattern Pf2 may be a constant pattern regardless of the rotational position and the rotational direction (e.g., the pattern illustrated in FIG. 16).

The forced-decay pattern may be any pattern that allows for applying the battery voltage to the motor 30 to flow the drive current Ib for braking the motor 30. The freewheeling pattern may be any pattern that allows the freewheeling current to flow in the same direction as the three-phase current generated by the immediately preceding ON-sequence.

In S531, the control circuit 50 calculates (or acquires) a main pattern time Tpm, a forced-decay pattern time Tpr, and a freewheeling pattern time Tpf. In S531, the first through third dead times may also be calculated (or acquired).

S540 is identical to that of the first embodiment, and thus its description is omitted.

In S541, the control circuit 50 sets the twin-pulse sequence to the ON-sequence.

If it is determined in S510 that the twin-pulse sequence is not set to the INIT-sequence, the process proceeds to S551. In S551, the control circuit 50 determines whether the twin-pulse sequence is set to the ON-sequence. If the twin-pulse sequence is set to the ON-sequence, the process proceeds to S552.

In S552, the control circuit 50 executes the aforementioned first dead-time process. Specifically, the control circuit 50 sets the first dead time. If the first dead time has been calculated in S531, the control circuit 50 acquires that first dead time. Furthermore, the control circuit 50 determines the drive pattern for the first dead-time process in accordance with the current output count and rotational position. If the drive pattern for the first dead-time process has been determined in S520, the control circuit 50 acquires that drive pattern. Then, the control circuit 50 executes the first dead-time process (i.e., drives the inverter 42 in accordance with the determined drive pattern) during the first dead time.

In S553, the control circuit 50 drives the inverter 42 in accordance with the current main pattern (either the first main pattern Pm1 or the second main pattern Pm2) determined in S520.

In S554, the control circuit 50 sets the main pattern time Tpm calculated in S531 in the timer 53 and activates the timer 53 such that the driving in accordance with the main pattern continues for the main pattern time Tpm.

In S555, the control circuit 50 sets the twin-pulse sequence to the forced-decay sequence.

If the ON-sequence is not set in S551, the process proceeds to S561. In S561, the control circuit 50 determines whether the twin-pulse sequence is set to the forced-decay sequence. If the twin-pulse sequence is set to the forced-decay sequence, the process proceeds to S562.

In S562, the control circuit 50 starts A/D conversion of the current detection signal (i.e., A/D conversion of the drive current Ib). Specifically, the A/D converter 52 starts the A/D conversion.

In S563, the control circuit 50 executes the aforementioned second dead-time process. Specifically, the control circuit 50 sets the second dead time. If the second dead time has been calculated in S531, the control circuit 50 acquires that second dead time. The control circuit 50 further determines the drive pattern for the second dead-time process in accordance with the current output count and rotational position. If the drive pattern for the second dead-time process has been determined in S520, the control circuit 50 acquires that drive pattern. Then, the control circuit 50 executes the second dead-time process (i.e., drives the inverter 42 in accordance with the determined drive pattern) during the second dead time. In the second dead-time process of the second embodiment, the control circuit 50 turns off all the switching elements Q1 through Q6 as described above.

In S564, the control circuit 50 drives the inverter 42 in accordance with the current forced-decay pattern (either the first forced-decay pattern Pr1 or the second forced-decay pattern Pr2) determined in S520.

In S565, the control circuit 50 sets the forced-decay pattern time Tpr calculated in S531 in the timer 53 and activates the timer 53 such that the driving in accordance with the forced-decay pattern continues for the forced-decay pattern time Tpr.

In S566, the control circuit 50 sets the twin-pulse sequence to the OFF-sequence.

If the twin-pulse sequence is not set to the forced-decay sequence in S561, the process proceeds to S600 (FIG. 19). In S600, the control circuit 50 determines whether the twin-pulse sequence is set to the OFF-sequence. If the twin-pulse sequence is set to the OFF-sequence, the process proceeds to S601.

In S601, the control circuit 50 executes the aforementioned third dead-time process. Specifically, the control circuit 50 sets the third dead time. If the third dead time has been calculated in S531, the control circuit 50 acquires that third dead time. The control circuit 50 further determines the drive pattern for the third dead-time process in accordance with the current output count and rotational position. If the drive pattern for the third dead-time process has been determined in S520, the control circuit 50 acquires that drive pattern. Then, the control circuit 50 executes the third dead-time process (i.e., drives the inverter 42 in accordance with the determined drive pattern) during the third dead time.

In S602, the control circuit 50 drives the inverter 42 in accordance with the current freewheeling pattern (either the first freewheeling pattern Pf1 or the second freewheeling pattern Pf2) determined in S520.

In S603, the control circuit 50 sets the freewheeling pattern time Tpf calculated in S531 in the timer 53 and activates the timer 53 such that the driving in accordance with the freewheeling pattern continues for the freewheeling pattern time Tpf.

In S640, the control circuit 50 sets the twin-pulse sequence to the completion-sequence.

If the twin-pulse sequence is not set to the OFF-sequence in S600, the twin-pulse sequence is set to the completion-sequence. In this case, the process proceeds to S650. In S650, the control circuit 50 acquires the result of the A/D conversion started in S562 from the A/D converter 52 and stores the result in the memory 51 as the current drive current value (first current value or second current value).

### 2-3. Third Embodiment

### [2-3-1. Features of Twin-Pulse Drive]

Yet another embodiment of the twin-pulse drive will be described as a third embodiment. The hardware configuration of the electric work machine of the third embodiment is basically the same as those of the first and second embodiments, except for the timer 53. The electric work machine of the third embodiment differs from the electric work machine of the first embodiment in the timer 53, the twin-pulse drive of S20, and the timer interrupt process.

In the twin-pulse drive of the third embodiment, similar to the second embodiment, driving in accordance with the main pattern, driving in accordance with the forced-decay pattern, and driving in accordance with the freewheeling pattern are performed in each of the first and second drive periods. That is, in the third embodiment, the twin-pulse drive identical or similar to the twin-pulse drive illustrated in FIGS. 15 and 16 is performed. Furthermore, specific details of the main pattern, the forced-decay pattern, and the freewheeling pattern (specific patterns corresponding to the rotational position and rotational direction) are also identical or similar to those of the second embodiment.

The most significant difference between the third embodiment and the second embodiment is the primary entity that executes the twin-pulse drive. Specifically, in the second embodiment, the processor 50a primarily executes the twin-pulse drive. In contrast, in the third embodiment, the timer 53 primarily executes the twin-pulse drive. That is, the processor 50a does not perform substantive control of the twin-pulse drive while performing minimal software-driven processing, such as activating the timer 53 and executing a timer interrupt (zero-interrupt) each time the count variable of the timer 53 reaches zero. In the third embodiment, the timer 53 is (i) activated by the processor 50a and (ii) executes the twin-pulse drive in accordance with the count variable. Once activated, the timer 53 repeatedly counts from an initial value (e.g., zero) to a target count value TCP.

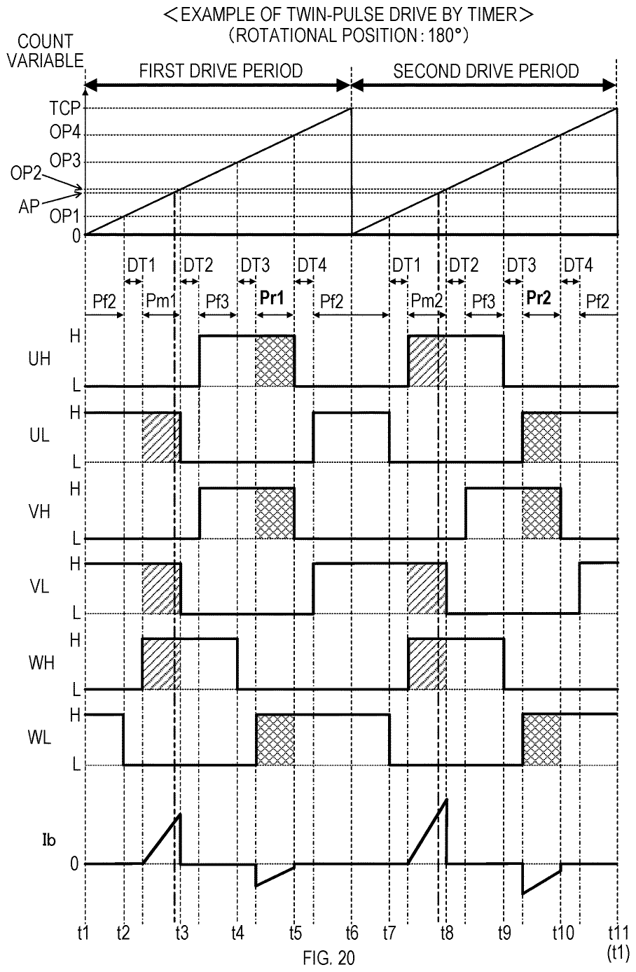

The twin-pulse drive of the third embodiment will be described with reference to FIG. 20. FIG. 20 illustrates, as an example, the twin-pulse drive when the detected rotational position is 180° and the rotational direction is the forward direction. In FIG. 20, at time t1, the timer 53 is activated by the processor 50a (specifically in S141, described later).

When the timer 53 is activated at time t1, the timer 53 starts the twin-pulse drive (specifically starts the first drive period) and drives the inverter 42 in accordance with the second freewheeling pattern Pf2. In the example of FIG. 20, the fourth through sixth switching elements Q4 through Q6 are turned on, and the other three are turned off.

When the count variable reaches OP1, the timer 53 drives the inverter 42 in accordance with the first main pattern Pm1 after the very short first dead-time process. In the example of FIG. 20, the third through fifth switching elements Q3 through Q5 are turned on, whereby rotational torque is generated in the motor 30 and the motor 30 rotates.

In the first dead-time process, the timer 53 turns off the sixth switching element Q6. This is because the third switching element Q3, which is in the same arm as the sixth switching element Q6, is turned on in the first main pattern Pm1. Execution time of the first dead-time process is a first dead time DT1. Although the first dead time DT1 is shown as being relatively long in FIG. 20 for ease of understanding, the first dead time DT1 is actually very short.

When the count variable reaches OP2, the timer 53 stops the driving in accordance with the first main pattern Pm1. Then, the timer 53 drives the inverter 42 in accordance with a third freewheeling pattern Pf3 after the very short second dead-time process.

In the second dead-time process, the timer 53 turns off the fourth and fifth switching elements Q4 and Q5. This is because the first and second switching elements Q1 and Q2, which are in the same arms as the fourth and fifth switching elements Q4 and Q5, respectively, are turned on in the third freewheeling pattern Pf3. Execution time of the second dead-time process is a second dead time DT2, which, like the first dead time DT1, is very short.

When the count variable reaches AP immediately before OP2, the timer 53 causes the A/D converter 52 to start A/D conversion of the drive current value. AP may be the same as OP2. By starting this A/D conversion, the peak value (or a value proximate thereto) of the drive current value in the first drive period, that is, the aforementioned first current value, can be obtained.

When the count variable reaches OP3, the timer 53 stops driving in accordance with the third freewheeling pattern Pf3. Then, the timer 53 drives the inverter 42 in accordance with the first forced-decay pattern Pr1 after the very short third dead-time process. Specifically, as in the second embodiment, the inverter 42 is driven in accordance with a pattern that is the direct opposite of the immediately preceding first main pattern Pm1 (“UH, VH, WL” in the example of FIG. 20).

In the third dead-time process, the timer 53 turns off the third switching element Q3. This is because the sixth switching element Q6, which is in the same arm as the third switching element Q3, is turned on in the first forced-decay pattern Pr1. Execution time of the third dead-time process is a third dead time DT3, which, like the first dead time DT1, is very short.

When the count variable reaches OP4, the timer 53 stops driving in accordance with the first forced-decay pattern Pr1. Then, the timer 53 drives the inverter 42 in accordance with the first freewheeling pattern Pf1 after a very short fourth dead-time process.

In the fourth dead-time process, the timer 53 turns off the first and second switching elements Q1 and Q2. This is because the fourth and fifth switching elements Q4 and Q5, which are in the same arms as the first and second switching elements Q1 and Q2, respectively, are turned on in the first freewheeling pattern Pf1. Execution time of the fourth dead-time process is a fourth dead time DT4, which, like the first dead time DT1, is very short.

When the count variable reaches the target count value TCP, the timer 53 (i) returns the count variable to the initial value (zero) and (ii) starts counting time from the initial value. This starts the next second drive period. The count variable reaching the target count value TCP means that one drive period has ended.

In the second drive period as well, the timer 53 switches the switch patterns in basically the same order as in the first drive period. That is, the first freewheeling pattern Pf1 is continued until the count variable reaches OP1. When the count variable reaches OP1, the timer 53 drives the inverter 42 in accordance with the second main pattern Pm2 after the first dead-time process. In the example of FIG. 20, the first, third, and fifth switching elements Q1, Q3, and Q5 are turned on. This generates rotational torque in the motor 30.

In the first dead-time process, the timer 53 turns off the fourth and sixth switching elements Q4 and Q6. This is because the first and third switching elements Q1 and Q3, which are in the same arms as the fourth and sixth switching elements Q4 and Q6, respectively, are turned on in the second main pattern Pm2.

When the count variable reaches OP2, the timer 53 drives the inverter 42 in accordance with a fourth freewheeling pattern Pf4 after the second dead-time process. In the second dead-time process, the timer 53 turns off the fifth switching element Q5. This is because the second switching element Q2, which is in the same arm as the fifth switching element Q5, is turned on in the fourth freewheeling pattern Pf4.

When the count variable reaches AP immediately before OP2, the timer 53 causes the A/D converter 52 to start A/D conversion of the drive current value. By starting the A/D conversion, the peak value (or a value proximate thereto) of the drive current value in the second drive period, that is, the aforementioned second current value, can be obtained.

When the count variable reaches OP3, the timer 53 drives the inverter 42 in accordance with the second forced-decay pattern Pr2 after the third dead-time process. Specifically, as in the second embodiment, the inverter 42 is driven with a pattern that is the direct opposite of the immediately preceding second main pattern Pm2 (“UL, VH, WL” in the example of FIG. 20). In the third dead-time process, the timer 53 turns off the first and third switching elements Q1 and Q3. This is because the fourth and sixth switching elements Q4 and Q6, which are in the same arms as the first and third switching elements Q1 and Q3, respectively, are turned on in the second forced-decay pattern Pr2.

When the count variable reaches OP4, the timer 53 drives the inverter 42 in accordance with the second freewheeling pattern Pf2 after the fourth dead-time process. In the fourth dead-time process, the timer 53 turns off the second switching element Q2. This is because the fifth switching element Q5 of the same arm will be turned on next.

When the count variable reaches the target count value TCP, the timer 53 (i) returns the count variable to the initial value (zero) and (ii) starts counting time from the initial value. This starts the next first drive period.

In this way, in the third embodiment, one twin-pulse drive is performed by repeating the count from 0 through TCP by the timer 53 twice. The timer 53 repeats the count from 0 through TCP. As a result, the twin-pulse drive is continuously performed until the rotational speed reaches the termination rotational speed.

In the first drive period, a range in which the count variable transitions from a first main start value (or OP1) to OP2 corresponds to the first energization period in the second embodiment. The first main start value is the count variable corresponding to the timing when the first dead time DT1 has elapsed from OP1.

In the first drive period, a range in which the count variable transitions from a first decay start value (or OP3) to OP4 corresponds to the first forced-decay period in the second embodiment. The first decay start value is the count variable corresponding to the timing when the third dead time DT3 has elapsed from OP3.

In the first drive period, a range in which the count variable transitions from a first freewheeling start value (or OP4) to TCP corresponds to the first freewheeling period in the second embodiment. The first freewheeling start value is the count variable corresponding to the timing when the fourth dead time DT4 has elapsed from OP4.

In the second drive period, a range in which the count variable transitions from a second main start value (or OP1) to OP2 corresponds to the second energization period in the second embodiment. The second main start value is the count variable corresponding to the timing when the first dead time DT1 has elapsed from OP1.

In the second drive period, a range in which the count variable transitions from a second decay start value (or OP3) to OP4 corresponds to the second forced-decay period in the second embodiment. The second decay start value is the count variable corresponding to the timing when the third dead time DT3 has elapsed from OP3.

In the second drive period, a range in which the count variable transitions from a second freewheeling start value (or OP4) to TCP corresponds to the second freewheeling period in the second embodiment. The second freewheeling start value is the count variable corresponding to the timing when the fourth dead time DT4 has elapsed from OP4.

### [2-3-2. Twin-Pulse Drive Process]

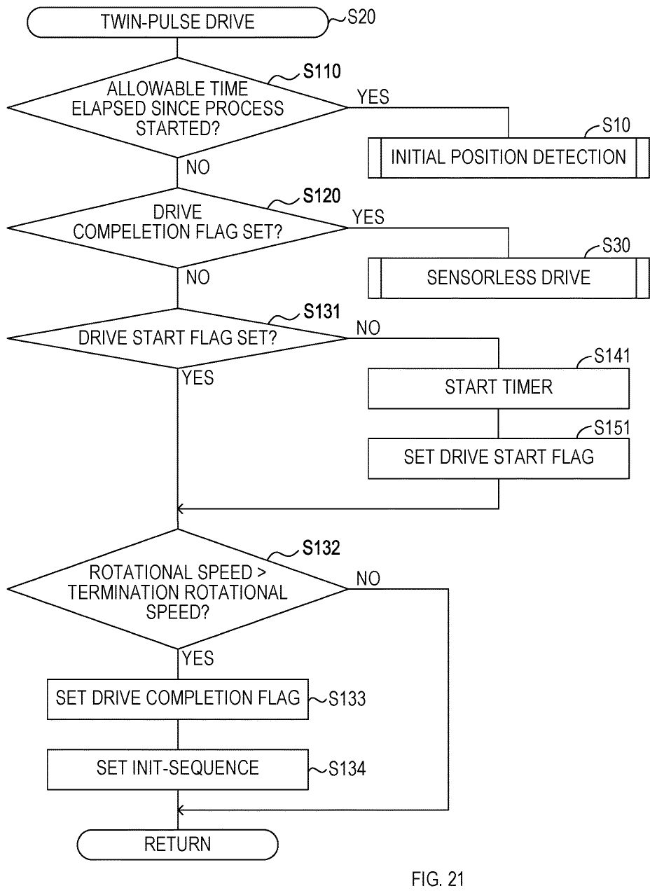

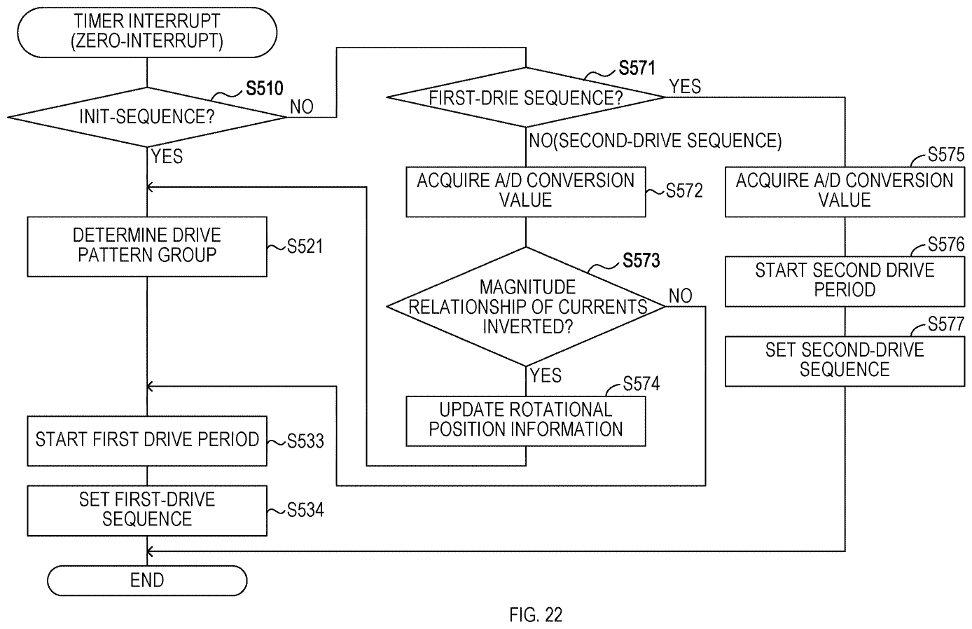

In the third embodiment, as in the first embodiment, the drive control process (FIG. 4) and the timer interrupt process are executed. However, the twin-pulse drive process of S20 in the drive control process and the timer interrupt process differ from those of the first embodiment. Therefore, the twin-pulse drive process and the timer interrupt process of the third embodiment will be described with reference to FIGS. 21 and 22. In FIGS. 21 and 22, processes identical to those in the first embodiment are denoted by the same reference numerals as in the first embodiment.

First, the twin-pulse drive process will be described with reference to FIG. 21. S110, S120, S10, and S30 are identical to those in the first embodiment, and thus their descriptions are omitted.

If the drive completion flag is not set in S120, the process proceeds to S131. In S131, the control circuit 50 determines whether a drive start flag is set. If the drive start flag is not set, the process proceeds to S141.

In S141, the control circuit 50 activates the timer 53. That is, the timer 53 starts counting time from the count variable “0”. In other words, the count variable is set to “0” at the start of counting. Therefore, in response to the timer activation in S141 (i.e., in response to the count variable being set to “0”), the timer interrupt of FIG. 22 is also initiated. In S141 (or in the subsequent S151), the control circuit 50 further sets the twin-pulse sequence to the INIT-sequence.

In S151, the control circuit 50 sets the drive start flag. After the processing of S151, the process proceeds to S132. The process also proceeds to S132 if the drive start flag is already set in S131.

In S132, the control circuit 50 determines whether the current rotational speed of the motor 30 exceeds the termination rotational speed. If the rotational speed does not exceed the termination rotational speed, the control circuit 50 temporarily terminates the twin-pulse drive process. If the rotational speed exceeds the termination rotational speed, the process proceeds to S133.

In S133, the control circuit 50 sets the drive completion flag. In S134, the control circuit 50 sets the twin-pulse sequence to the INIT-sequence. In the third embodiment as well, if the rotational speed does not exceed the termination rotational speed in S132, the processing of S180 through S250 in FIG. 9 may be performed.

Next, the timer interrupt process will be described with reference to FIG. 22. The timer interrupt process of FIG. 22 is executed each time the count variable is set to “0”.

The control circuit 50, when starting the timer interrupt process, determines in S510 whether the twin-pulse sequence is set to the INIT-sequence. If the twin-pulse sequence is set to the INIT-sequence, the process proceeds to S521.

In S521, the control circuit 50 determines the drive pattern groups for the first and second drive periods, respectively, in the same manner as in S520 in FIG. 18, based on the currently detected rotational position, the currently set output count, the rotational direction of the motor 30, and the switch pattern table shown in Table 1. In the third embodiment, the drive pattern group includes the main pattern, the forced-decay pattern, and the freewheeling pattern. The drive pattern group may include drive patterns for the first through fourth dead-time processes. The drive pattern group may also include all patterns illustrated in FIG. 20.

In S533, the control circuit 50 notifies the timer 53 of the drive pattern group determined in S521, thereby causing the timer 53 to start driving for the first drive period. Through this notification, the timer 53 can identify specifically which switching elements should be turned on (in other words, which switching elements should be turned off) during driving based on each pattern.

In S534, the control circuit 50 sets the twin-pulse sequence to a first-drive sequence.

If the twin-pulse sequence is not set to the INIT-sequence in S510, the process proceeds to S571. In S571, the control circuit 50 determines whether the twin-pulse sequence is set to the first-drive sequence. If the twin-pulse sequence is set to the first-drive sequence, the process proceeds to S575.

In S575, the control circuit 50 acquires the A/D conversion value of the drive current (i.e., the first current value). The first current value acquired here is the result of the A/D conversion initiated when the count variable reached AP. That is, this first current value is a peak value (or a value proximate thereto) of the drive current during driving in accordance with the first main pattern Pm1.

In S576, the control circuit 50 causes the timer 53 to start driving for the second drive period. At this time, the control circuit 50 notifies the timer 53 of the patterns used in the second drive period from the drive pattern group determined in S521.

In S577, the control circuit 50 sets the twin-pulse sequence to a second-drive sequence.

If the twin-pulse sequence is not set to the first-drive sequence in S571, the twin-pulse sequence is set to the second-drive sequence. Therefore, in this case, the process proceeds to S572.

In S572, the control circuit 50 acquires the A/D conversion value of the drive current (i.e., the second current value). The second current value acquired here is the result of the A/D conversion initiated when the count variable reached AP in the most recent second drive period. That is, this second current value is a peak value (or a value proximate thereto) of the drive current during driving in accordance with the second main pattern Pm2 in the most recent second drive period.

In S573, the control circuit 50 determines whether the magnitude relationship between the first current value and the second current value in the current twin-pulse drive is inverted from that in the previous twin-pulse drive. If the first current value and the second current value were equal in the previous twin-pulse drive, the magnitude relationship in the twin-pulse drive performed two cycles ago is used for comparison.

If the magnitude relationship is not inverted in S573, the process proceeds to S533. In this case, the control circuit 50 again executes the twin-pulse drive in accordance with the drive pattern group determined in the immediately preceding S521. If the magnitude relationship is inverted, the process proceeds to S574.

In S574, the control circuit 50 updates the rotational position information in the same manner as in S390 (FIG. 10). After the processing of S574, the process proceeds to S521. That is, if the rotational position information is updated, the control circuit 50 determines a new drive pattern group based on the new rotational position. As a result, the twin-pulse drive is executed in accordance with the new drive pattern group.

As described above, in the third embodiment, the major parts of the twin-pulse drive (driving in accordance with the main pattern, subsequent driving in accordance with the forced-decay pattern, and subsequent driving in accordance with the freewheeling pattern) are basically identical or similar to those in the second embodiment. However, the primary entity for these drivings is the timer 53. Consequently, in the third embodiment, the processing load on the processor 50a is reduced.

In the third embodiment, driving in accordance with the third freewheeling pattern or the fourth freewheeling pattern is performed between the driving in accordance with the main pattern and the driving in accordance with the forced-decay pattern. However, the driving in accordance with the third freewheeling pattern and/or the fourth freewheeling pattern may be omitted. That is, the twin-pulse drive of the third embodiment may be performed in exactly the same order as the twin-pulse drive of the second embodiment. Specifically, in the third embodiment as well, the twin-pulse drive may be performed, in each of the first and second drive periods, in the following order: completion-sequence, INIT-sequence, first dead-time process, ON-sequence, second dead-time process, forced-decay sequence, third dead-time process, and OFF-sequence. However, one or more sequences (except for the ON-sequence and the forced-decay sequence) may be omitted from this ordered arrangement.

### 2-4. Other Embodiments

While the embodiments for implementing the present disclosure have been described above, the present disclosure is not limited to the above-described embodiments and can be implemented with various modifications.

For example, in the first embodiment, the control of the output duty in the twin-pulse drive is described as comparing the current flowing through the motor 30 with the desired current and updating the output duty such that the current flowing through the motor 30 reaches the desired current.

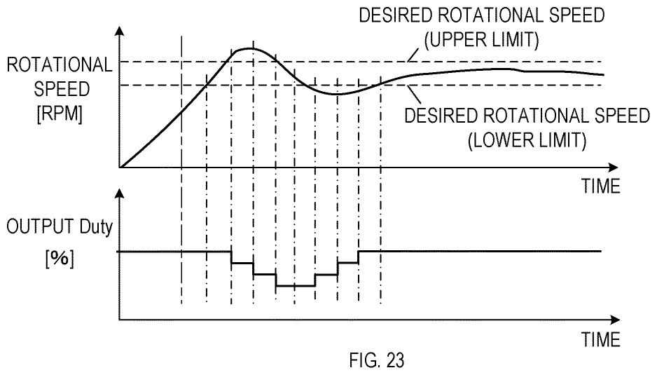

In contrast, as illustrated in FIG. 23, a target rotational speed of the motor 30 may be set, and the output duty may be updated such that the rotational speed of the motor reaches this target rotational speed. FIG. 23 illustrates an example in which an upper limit and a lower limit of the target rotational speed are set, and the motor 30 is driven such that the rotational speed falls between the upper limit and the lower limit (i.e., within a permissible rotational speed range).

Furthermore, the electric work machine of the present disclosure may be configured to set commutation timing by twin-pulse drive, similar to those described in the embodiments and variations of Japanese Patent No. 7118699. In any configuration, if the output duty is controlled in accordance with the load applied to the motor 30 in the same manner as in the above embodiments, effects similar to those of the above embodiments can be obtained.

Furthermore, in the above embodiments, the electric work machine 1 is described as having a configuration where the multiple work units exemplified in FIG. 2 are interchangeable. However, the technique of the present disclosure can be applied to any electric work machine equipped with a brushless DC motor as a power source, similar to the above embodiments.

That is, the technique of the present disclosure can be applied to electric work machines for masonry, metalworking, and woodworking, as well as gardening machines. More specifically, the technique can be applied to various electric work machines such as electric hammers, electric hammer drills, electric drills, electric screwdrivers, electric wrenches, electric grinders, electric circular saws, electric reciprocating saws, electric jigsaws, electric cutters, electric chainsaws, electric planers, electric nailers (including tackers), electric hedge trimmers, electric lawn clippers, electric brush cutters, electric cleaners, electric blowers, electric sprayers, electric spreaders, and electric dust collectors.

Multiple functions possessed by a single component in the above embodiments may be achieved by multiple components, and a single function possessed by a single component may be achieved by multiple components. Conversely, multiple functions possessed by multiple components may be achieved by a single component, and a single function possessed by multiple components may be achieved by a single component. Also, a part of the configuration of the above embodiments may be omitted. Additionally, at least part of the configuration of one of the above embodiments may be added to or replaced with the configuration of another of the above embodiments.

What is claimed is:

1. An electric work machine comprising:
a brushless DC motor (i) being a power source for operating a work tool and (ii) including multiple terminals and multiple windings;
an inverter including (i) multiple energization paths each coupling the multiple terminals to a DC power source and (ii) multiple switching elements each provided on the multiple energization paths, the inverter being configured to control energization and an energizing direction to the multiple windings via the multiple switching elements; and
a control circuit configured to execute:
a first operation of switching a setting of a switch pattern pair at each commutation timing of the brushless DC motor, the switch pattern pair including a first pattern and a second pattern, each of the first pattern and the second pattern specifying ON/OFF states of the multiple switching elements for energizing the multiple windings via the inverter, the ON/OFF states of the first pattern being different from the ON/OFF states of the second pattern;
a second operation of alternately switching a setting of a switch pattern between the first pattern and the second pattern corresponding to the switch pattern pair that is set, in synchronization with a PWM control cycle;
a third operation of executing PWM control of an energization current to the multiple windings in synchronization with the PWM control cycle, the third operation including turning each of the multiple switching elements ON or OFF in accordance with the switch pattern switched by the second operation;
a fourth operation of setting the commutation timing based on a timing when a magnitude relationship between an inductance of a first energization path and an inductance of a second energization path is reversed, the first energization path being a path in the multiple windings through which a current from the DC power source flows when the switch pattern is set to the first pattern, and the second energization path being a path in the multiple windings through which a current from the DC power source flows when the switch pattern is set to the second pattern; and
a fifth operation of setting a duty cycle of the PWM control based on a load applied from the work tool to the brushless DC motor, the duty cycle being (i) a proportion of time during which the inverter is controlled in accordance with the first pattern to a length of the PWM control cycle, and/or (ii) a proportion of time during which the inverter is controlled in accordance with the second pattern to the length of the PWM control cycle.

2. The electric work machine according to claim 1,
wherein the control circuit is configured to:
execute a sixth operation of (i) setting the commutation timing based on a back EMF and (ii) turning each of the multiple switching elements ON or OFF in accordance with an energization pattern corresponding to the set commutation timing to thereby execute the PWM control, the back EMF being generated in the multiple windings by rotation of the brushless DC motor; and
execute the first through fifth operations while bypassing the sixth operation based on a rotational speed of the brushless DC motor being less than or equal to a termination rotational speed.

3. The electric work machine according to claim 1,
wherein the fifth operation includes setting the duty cycle such that a magnitude of a current flowing through the brushless DC motor while the third operation is being executed maintains a current target, the current target being set such that the brushless DC motor is rotatable.

4. The electric work machine according to claim 3,
wherein a permissible current range from a desired current lower limit to a desired current upper limit is set as the current target, the desired current upper limit being larger than the desired current lower limit, and
wherein the fifth operation includes increasing or decreasing the duty cycle such that the magnitude of the current is maintained within the permissible current range.

5. The electric work machine according to claim 3,
wherein the fifth operation includes increasing the current target stepwise at every target update cycle, the target update cycle being longer than the PWM control cycle.

6. The electric work machine according to claim 1,
wherein the third operation includes:
alternately generating a first drive period and a second drive period in synchronization with the PWM control cycle, the first drive period including a first energization period and a first forced-decay period after the first energization period, and the second drive period including a second energization period and a second forced-decay period after the second energization period;
controlling the multiple switching elements in accordance with the first pattern in the first energization period;
controlling the multiple switching elements in accordance with a first forced-decay pattern in the first forced-decay period;
controlling the multiple switching elements in accordance with the second pattern in the second energization period; and
controlling the multiple switching elements in accordance with a second forced-decay pattern in the second forced-decay period,
wherein the first forced-decay pattern is set to apply a DC voltage of the DC power source to the brushless DC motor via the inverter, thereby allowing at least a portion of first magnetic energy accumulated in the multiple windings during the first energization period to be discharged externally from the brushless DC motor,
wherein the second forced-decay pattern is set to apply the DC voltage to the brushless DC motor via the inverter, thereby allowing at least a portion of second magnetic energy accumulated in the multiple windings during the second energization period to be discharged externally from the brushless DC motor, and
wherein each of a ratio of a length of the first energization period to a length other than the first energization period in the first drive period, and a ratio of a length of the second energization period to a length other than the second energization period in the second drive period, corresponds to the duty cycle.

7. The electric work machine according to claim 6,
wherein the first forced-decay pattern and the second forced-decay pattern are set such that a regenerative current flows from the brushless DC motor to a positive electrode of the DC power source via the inverter.

8. The electric work machine according to claim 6,
wherein the first forced-decay pattern is set such that ON/OFF states of the multiple switching elements are opposite to the ON/OFF states in a case where the multiple switching elements are controlled in accordance with the first pattern.

9. The electric work machine according to claim 6,
wherein the second forced-decay pattern is set such that ON/OFF states of the multiple switching elements are opposite to the ON/OFF states in a case where the multiple switching elements are controlled in accordance with the second pattern.

10. The electric work machine according to claim 6,
wherein a length of the first energization period, a length of the first forced-decay period, a length of the second energization period, and a length of the second forced-decay period are set such that an average value of a drive current in a pair period, which is a consecutive period of one first drive period and one second drive period, is less than 30% of a peak value of the drive current in the pair period; and
wherein the drive current is a current flowing between the DC power source and the brushless DC motor via the inverter.

11. The electric work machine according to claim 6,
wherein a length of the first energization period, a length of the first forced-decay period, a length of the second energization period, and a length of the second forced-decay period are set such that an average value of a forward-direction phase current in a pair period, which is a consecutive period of one first drive period and one second drive period, is less than 80% of a peak value of the forward-direction phase current in the pair period; and
wherein the forward-direction phase current is a current, among multiple currents respectively flowing through the multiple terminals, which flows in a direction of flowing from the inverter into the brushless DC motor in both the first energization period and the second energization period.

12. The electric work machine according to claim 6,
wherein the first drive period includes a first freewheeling period after the first forced-decay period,
wherein the third operation includes controlling the multiple switching elements in accordance with a first freewheeling pattern in the first freewheeling period, and
wherein the first freewheeling pattern is set to form a first closed circuit for allowing a freewheeling current based on the first magnetic energy to flow, the first closed circuit including the brushless DC motor and the inverter and not including the DC power source.

13. The electric work machine according to claim 6,
wherein the second drive period includes a second freewheeling period after the second forced-decay period,
wherein the third operation includes controlling the multiple switching elements in accordance with a second freewheeling pattern in the second freewheeling period, and
wherein the second freewheeling pattern is set to form a second closed circuit for allowing a freewheeling current based on the second magnetic energy to flow, the second closed circuit including the brushless DC motor and the inverter and not including the DC power source.

14. The electric work machine according to claim 6,
wherein the length of the first forced-decay period is equal to the length of the second forced-decay period in a pair period, which is a consecutive period of one first drive period and one second drive period.

15. The electric work machine according to claim 6,
wherein in the first drive period, the length of the first forced-decay period is set to increase as the length of the first energization period increases.

16. The electric work machine according to claim 6,
wherein in the second drive period, the length of the second forced-decay period is set to increase as the length of the second energization period increases.

17. The electric work machine according to claim 6,
wherein the control circuit includes:
a processor configured to execute a part or all of the first operation, second operation, fourth operation and fifth operation; and
a timer configured to execute a part or all of the third operation, the timer being (i) hardware provided separately from the processor, (ii) configured to be started by the processor, and (iii) configured to repeat counting from an initial value to a count target value in response to being started by the processor,
wherein each of the first drive period and the second drive period corresponds to a period from the initial value to the count target value; and
wherein the timer is further configured to execute at least one of:
outputting a control signal for controlling the multiple switching elements in accordance with the first pattern while a count variable of the timer is in a range corresponding to the first energization period;
outputting the control signal for controlling the multiple switching elements in accordance with the first forced-decay pattern while the count variable of the timer is in a range corresponding to the first forced-decay period;
outputting the control signal for controlling the multiple switching elements in accordance with the second pattern while the count variable of the timer is in a range corresponding to the second energization period; and
outputting the control signal for controlling the multiple switching elements in accordance with the second forced-decay pattern while the count variable of the timer is in a range corresponding to the second forced-decay period.

18. The electric work machine according to claim 1,
wherein the fourth operation includes detecting a rotational position of the brushless DC motor and setting the commutation timing at a timing when a magnitude relationship between a first level and a second level is reversed, the first level indicating a magnitude of a current that has flowed through the energization path in a first energization period, and the second level indicating a magnitude of a current that has flowed through the energization path in a second energization period following the first energization period;
wherein the first energization period is a period during which the multiple switching elements are controlled in accordance with the first pattern; and
wherein the second energization period is a period during which the multiple switching elements are controlled in accordance with the second pattern.
